(19) United States
(12) Patent Application Publication
(10) Pub. No.: US 2008/0077951 A1
(43) Pub. Date: Mar. 27, 2008

(54) Television ratings based on consumer-owned data

(75) Inventors: Frank S. Maggio, Pinellas Park, FL (US); Michael J. Vinson, Chicago, IL (US)

Correspondence Address: KING & SPALDING LLP, 1180 PEACHTREE STREET, ATLANTA, GA, 30309-3521, US

(73) Assignee: ERINMEDIA, LLC

(21) Appl. No.: 11/897,761

(22) Filed: Aug. 31, 2007

Related U.S. Application Data
(60) Provisional application No. 60/842,261, filed on Sep. 1, 2006.

(51) Int. Cl. H04N 7/16; H04H 9/00; H04H 60/33

(52) U.S. Cl. 725/9

(57) ABSTRACT

Systems and methods for providing television ratings based upon data from consumer-owned set-top boxes. Consumers can decide to share television viewing data with a ratings provider. Consumers also can decide to share viewing data periodically or continuously, and whether they will share their demographic data with the ratings provider. The ratings provider can aggregate all of the data and associated demographic data of consumers sharing viewing data continuously, and compare the aggregated data with the viewing data of consumers sharing viewing data periodically, thereby validating the aggregated data. A ratings provider collecting viewing behavior from set-top boxes owned by service providers, and also from opt-in consumer-owned set-top boxes, can extrapolate from the sample sets viewership behavior attributes of the consumers who own set-top boxes and have elected not to opt-in for data collection. Additionally, such a ratings provider can extrapolate demographic data of opt-in consumers to the entire ratings population.

### RELATED APPLICATIONS

This patent application claims priority under 35 U.S.C. § 119 to U.S. Provisional Patent Application No. 60/842,261, entitled “Television Ratings Based On Consumer-Owned Data,” filed Sep. 1, 2006, the complete disclosure of which is hereby fully incorporated herein by reference.

### TECHNICAL FIELD

The invention relates to systems and methods for monitoring and measuring television ratings, as well as advertising reach and frequency. In particular, the invention provides systems and methods for providing television ratings based upon data collected directly from consumers, wherein the consumers can determine a level of participation in providing television viewing data and an amount and type of viewing and demographic data to provide, while protecting consumers' personally identifiable information, if so desired by the participant.

### BACKGROUND

Nearly every business seeks to advertise itself to potential consumers. Reaching the largest number of potential consumers is a major concern to many of these businesses. Arguably, the most far-reaching, effective, and significant method of advertising is television advertising.

A major reason why television advertising is effective is that television viewing is one of the most popular activities in the world. Hundreds of millions of people within the United States, for example, watch television for news and entertainment. Furthermore, the purchasing power of these television viewers makes them a highly desirable target for commercial advertising.

Because television advertisements have the ability to reach such a large volume of consumers, businesses are willing to spend millions of dollars to have their commercial messages broadcast via television. Industry estimates indicate that television advertising revenue in the United States alone may exceed $70 billion in 2006.

Given the large sums of money involved, businesses that advertise on television go to great lengths ensure that their advertisements will reach a population that will buy enough of the product or service advertised to generate sufficient revenue to offset the cost of advertising. Advertisers consider two main factors when deciding the price they are willing to pay for television advertising: the number and demographic makeup of television viewers (known as reach) and the number of times the viewers are exposed to the advertising message (known as frequency).

The importance of each of these factors is clear. A higher number of people likely to watch a given advertisement translates into a higher number of potential consumers for the product advertised. Businesses are therefore willing to spend more money for a schedule of advertisements likely to be seen by fifty million people over the course of a week than for those likely to be seen only by ten million people. Additionally, differentiating between duplicated and unduplicated viewers is also important; i.e., were the advertisements seen by fifty million different people or were five million people exposed to the advertisements ten times each?

In addition to targeting a large population when advertising, businesses also consider whether an advertisement will reach the “right” population. Advertisers may be willing to spend more per viewer if the advertising vehicle targets viewers whose demographic profile matches that of the typical consumer of the advertised product or service. For example, a golf club manufacturer may be willing to spend $5 per thousand viewers when advertising on the network broadcast of a PGA event but may be willing to spend $25 per thousand viewers when advertising on the Golf Channel's equipment review telecast, because the viewers are much more likely to be avid golfers in the market for new equipment.

Businesses considering advertising on television therefore need detailed information regarding the size, makeup, and demographics of the likely viewing population for a given advertisement or product placement. Because advertisements and product placements on television can occur at almost any time, the information advertisers seek must be detailed and available on a second-by-second basis.

The television ratings industry developed for the primary purpose of providing information concerning the size and demographics of the likely viewing population of television programs. Although the method utilized by different providers of such information varies, the basic principle involves obtaining a very small sample population of television viewers, gathering the demographic data of the sample, monitoring the television viewing habits of the sample, correlating the demographic data of the sample with the viewing habits, and extrapolating the information and analysis of the sample to the entire population.

One of the most well-known providers of television ratings is Nielsen Media Research (“Nielsen”). To calculate national ratings, Nielsen employs a sample size of approximately 10,000 households, which comprises about 30,000 people. The only way for a household to be included in the Nielsen sample is if Nielsen recruits that household; the Nielsen model does not provide a means for a consumer to volunteer to be in the sample. When Nielsen recruits a consumer household to be part of the Nielsen sample, the household can accept or decline the invitation. To collect television viewing data from a household that agrees to be sampled, Nielsen uses an electronic device connected to each television monitor within the sample household which detects the programs being displayed. Nielsen owns this electronic device, and thus owns the data collected by the device.

Nielsen uses the electronic device (or alternatively, asks users to self-report their viewing) to gather demographic data from each of the people in the sampled households, and binds the demographic data to the television viewing data through a remote control. When a viewer in the household is watching television, they are required to push a button on the remote control that indicates that person is watching television. The combined demographic and viewing data is then extrapolated though statistical analysis to the entire population of American television viewers to generate ratings information.

The Nielsen methodology for providing television ratings has noticeable drawbacks. First, Nielsen's small sample size excludes over 99.98% of the approximately 100 million households in America. Due to the small sample size and the fact that the average American television viewer can have 200 television channels or more to choose from when engaged in television viewing, Nielsen's ratings are prone to very large error and uncertainty. Additionally, the ratings are predicated on the premise that the sample is drawn using a random and representative process.

In addition, by excluding over 99.98% of all American households, and indeed, by failing to allow a household to play an active part in the ratings process, virtually every household, except for a miniscule hand-picked and paid minority, is not able to participate in the process of deciding which programs succeed and which fail. This indirectly disenfranchises the non-participating households from also participating in the process of determining how over $70 billion of advertising is expended each year.

A simple solution to the shortcomings of Nielsen's approach would be to radically increase the size of their national sample. Increasing the size to 10,000,000 households would reduce the errors associated with sample size, dramatically reduce any bias associated with a non-random sample, increase the likelihood the sample would be representative, and increase the number of households able to democratically participate in the determination of successful television programs and advertisers, perhaps by more than several thousand-fold. However, because Nielsen's method of collecting television viewing data includes providing a specialized electronic device to each sampled household, increasing the sample size to represent a larger proportion of the public would be prohibitively expensive.

Nielsen's approach also requires that household members push buttons when they are watching television. This requirement directly affects the activity being measured and reinforces the fact that viewing activity is being monitored, both of which reduce the quality of Nielsen's rating estimates.

Another drawback of the Nielsen methodology for providing ratings is that Nielsen must assume that the viewing habits of the households that do not want to be, or otherwise are not, part of the sample are the same as the viewing habits of those who agree to be part of the sample. A significant portion of the population (industry estimates non-compliance at more than 50%) may not wish to share their viewing habits with Nielsen, given that they also must disclose private data and demographic data. Should people that have such concerns view television differently than those who do not, the viewing associated with that segment of the television viewing population will not be reflected in Nielsen's estimates.

In contrast to Nielsen's method of providing television ratings, other ratings providers utilize alternative methods allowing for a much larger sample size. For example, in the MSO-STB model, a ratings provider can collect television viewing data from set-top boxes (STBs) that are placed in households and are owned by the multiple system operators (MSOs) or telecommunication service providers that provide television service to the households. Analyzing the data passing through a consumer's STB would indicate what channel the consumer was watching at any given time and what content was sent to the monitor. Additionally, should the content information not be available, the channel could be tied to content via a programming guide or other external data source to determine what content was displayed. Because STBs are already used by millions of Americans to watch television, the television viewing data can be collected from a sample much larger than the 10,000 households sampled by Nielsen. The television viewing data processed by the STBs is owned by the MSOs, and therefore permission to collect the data is subject to the motivation of the MSOs.

The MSO-STB model as described has a few deficiencies. For example, demographic data may not be directly associated with television viewing data as it is in the Nielsen method. This difficulty occurs because the consumers have no direct way to append their viewing data with their demographic characteristics. Typically, the data from an STB in a household is limited to only the television viewing data for that household and the zip code in which the household is located. To estimate demographic ratings, an optimal MSO-STB model can employ inverse mathematics to determine the relationship between television viewing at the zip code level and demographic data at the zip code level. This approach is analogous to solving a jigsaw puzzle and is very effective when all of the pieces are available. In many markets the consumer may opt to receive their television over the air, through a cable operator, through one of several satellite providers, through at least one telecom operators, and finally, through a broadband internet provider. All of these providers control the pieces to the ratings jigsaw puzzle and the MSO-STB model is most effective when all of the data is available.

Perhaps the most significant deficiency of the MSO-STB model, the Nielsen model, and other models currently known in the art is that they all require that the viewership data and the device for collecting the data be owned by the ratings provider or the MSO, and not by the consumer. Although this may be the predominant model in American households today, as most consumers do not own an STB, technological development and competitive forces may soon create an environment where consumers will be allowed to purchase their own STBs—or purchase a television with a built-in STB—that can communicate with any service provider via an industry standard platform.

In households where the consumer, rather than the service provider or ratings provider, owns the STB, the MSO-STB model of providing ratings would be further complicated because permission would need to be obtained from each STB owner, and an efficient method of obtaining such permission does not currently exist. Furthermore, without a consolidated “aggregator” of a vast number of these consumer-owned STB households, the likelihood of more than one aggregator obtaining sufficient quantities of participating households in order to provide inverse mathematic-derived demographic ratings, in a privacy compliant manner, is unlikely.

Therefore, a need in the art exists for a method and system for providing accurate television ratings information that address the deficiencies and drawbacks of the current methods of providing ratings, such as the Nielsen model and the MSO-STB model. Given the massive shift in the control of information used to calculate television ratings from the ratings providers to the consumers, a need in the art exists for new methods, systems, technology, and incentives that can adjust for this massive shift. Specifically, a need exists for an accurate and cost-effective way to provide television ratings based upon data retrieved from STBs that are owned by consumers, and not an MSO or a ratings provider. A further need exists for doing so based upon a large sample size. Another need exists for allowing consumers to decide if they wish to share their television viewing data with a ratings provider or not, and to determine the frequency at which the data is shared. Yet another need exists for allowing consumers who share television viewing data to determine the amount of demographic data to supply to the ratings provider. On a related point, a need exists for determining the differences in behavior, if any, between consumers who allow varied levels of shared television viewing data and those that do not allow their viewing behavior to be shared. Furthermore, a need exists for a means by which ratings information based upon a large sample size of consumers electing to share their television viewing data and demographic and identifying information can be validated, to ensure that the viewing habits of such a sample are not significantly different from the viewing habits of other consumers.

### SUMMARY OF THE INVENTION

The invention provides methods and systems for providing ratings information based upon data collected from set-top boxes owned by consumers. The consumers who elect to share their viewing information with a ratings provider can determine the extent of viewing, identifying, and demographic data shared with the ratings provider.

In one aspect of the invention, a consumer owning an STB that receives content from an MSO can set preferences indicating the extent to which the consumer wishes to share data with a ratings provider. The consumer can choose to be in any one of the following five categories of consumers with respect to sharing data with a ratings provider: (1) the consumer is not willing to share any data; (2) the consumer is only willing to share data that indicates the programs watched periodically; (3) the consumer is willing to share continuously data that indicates the programs watched and the consumer's zip code; (4) the consumer is willing the share continuously data that indicates the programs watched and demographic data of one or more members of the consumer's household; or (5) the consumer is willing to share continuously data that indicates the programs watched, demographic data of one or more members of the consumer's household, and the members of the consumer's household that are watching content through the consumer's STB at any given time. Consumer data then can be shared with a ratings provider according to the category of data sharing preferences selected by the consumer.

In another aspect of the invention, a consumer's STB can store data indicating the programs watched by a consumer by storing a first time at which a consumer selects a channel to watch, storing the channel selected by the consumer, and storing a second time at which a consumer selects a different channel or turns the STB off. Such viewership or “time/channel” data then can be communicated to an information processing unit via a network. An MSO-specific programming guide that comprises the programs shown on any given channel at any given time can be communicated from the consumer's MSO to the information processing unit via a network. The information processing unit then can determine the programs watched by the consumer from the time/channel data and the programming guide and then can store the programs watched as programming data.

In another aspect of the invention, programming data based upon time/channel data shared continuously by consumers with a sharing preference of category 3, 4, or 5 can be associated with the demographic data corresponding with the consumer's household. If the consumer shared only the consumer's zip code and not demographic data, then the demographic data of the consumer's zip code can be associated with the programs watched by the consumer.

In another aspect of the invention, all continuously shared data indicating programs watched by consumers with a sharing preference of category 3, 4, or 5, after being associated with corresponding demographic data, can be aggregated into a first set of ratings information. Then, all periodically shared data indicating the programs watched by the consumers with a sharing preference of category 2 can be retrieved and aggregated into a second set of ratings information, and then compared with the first set. If the second set of ratings information validates the first set, then the first set of ratings information can be reported as television ratings.

In another aspect of the invention, all consumer owned data indicating programs watched by consumers with a sharing preference of category 2, 3, 4, or 5, after being associated with corresponding demographic data, can be extrapolated to apply to data from STBs not owned by consumers, such as those owned by MSOs.

In yet another aspect of the invention, a ratings provider who collects a significant majority of viewing behavior from MSO owned STBs, and also a portion of opt-in consumer owned STBs, would also be able to extrapolate from the two sample sets certain viewership behavior attributes of the consumers who own STBs but have elected not to opt-in for data collection.

Such extrapolation may only require limited information from a rather small subset of television viewers, and may not be particularly sensitive to errors in the user-provided data or bias in the recruited sample population. In addition, such extrapolation may not require the viewer to record viewing behavior using a diary or a separate electric monitoring device. Instead, time/channel data for consumers and households sharing demographic data can be collected using the same passive method as it would be for consumers that share only time/channel data.

By recording and analyzing state-change data such as time/channel data coming from STBs, household and consumer ratings can be provided, and demographic-specific ratings then can be calculated and extrapolated based on demographic data provided. Using such demographic data to extrapolate demographic-specific ratings for a larger population is different from the purely small-sample methodology currently accepted in the industry. The latter approach uses data solely from a relatively small number of recruited (opt-in) households. Moreover, not only is demographic data self-reported, but so is the television viewing.

In contrast, certain aspects of the invention combine the self-reported demographics of a relatively small subset of consumers with time/channel data from a larger sample of the subscribers in the measured markets, with each measured market including up to several hundred thousand households. The households that choose to opt-in simply can fill out a survey form once, and from that time forward can be monitored passively and need not report any on-going information, although there may be occasional follow-up surveys to track changes in household makeup and behavior.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for generating ratings based on consumer-owned data according to an exemplary embodiment.

FIG. 2 is a block diagram depicting a system for providing television ratings information based at least partly upon data collected from a household with multiple consumers according to an exemplary embodiment.

FIG. 3 is a block diagram depicting a system for providing television ratings information based at least partly upon data collected from multiple households serviced by an MSO according to an exemplary embodiment.

FIG. 4 is a block diagram depicting a system for generating ratings based on consumer-owned data, the system comprising multiple MSOs each communicating with multiple STBs according to another exemplary embodiment.

FIG. 5 is a flow chart depicting a method for generating television ratings based upon data collected from multiple consumers according to an exemplary embodiment.

FIG. 6 is a flow chart depicting a method for collecting consumer data according to an exemplary embodiment.

FIG. 7 is a flow chart depicting a method for collecting consumer data according to predefined preferences determined by the consumer according to an exemplary embodiment.

FIG. 8 is a flow chart depicting a method for collecting consumer data based on category 2 data sharing preferences according to an exemplary embodiment.

FIG. 9 is a flow chart depicting a method for collecting consumer data based on category 3 data sharing preferences according to an exemplary embodiment.

FIG. 10 is a flow chart depicting a method for collecting consumer data based on category 4 data sharing preferences according to an exemplary embodiment.

FIG. 11 is a flow chart depicting a method for collecting consumer data based on category 5 data sharing preferences according to an exemplary embodiment.

FIG. 12 is a flow chart depicting a method for storing time/channel data in a consumer's STB according to an exemplary embodiment.

FIG. 13 is a flow chart depicting a method for converting time/channel data to programming data according to an exemplary embodiment.

FIG. 14 is a flow chart depicting a method for calculating a set of ratings based on data retrieved from consumers sharing data continuously according to an exemplary embodiment.

FIG. 15 is a flow chart depicting a method for calculating a set of ratings based upon data retrieved from consumers sharing data periodically and consumers sharing data continuously according to an exemplary embodiment.

### DETAILED DESCRIPTION OF THE EXEMPLARY EMBODIMENTS

As used throughout the application, the term “demographic” or “demographic data” refers to characteristics of a population, sample, or individual, including but not limited to race, ethnicity, gender, age, religion, income level, educational background, profession, and geographic location

As used throughout the application, the term “television ratings” refers to an analysis of the viewing population of a given television program or channel, including but not limited to an estimate of the number of viewers and/or the demographics of the viewers watching a given television channel at a given time.

As used throughout the application, the term “multiple system operator” or “MSO” refers to an operator of multiple cable television systems. A cable system is generally considered to be a facility serving a single community or a distinct entity. Therefore cable companies that serve multiple communities or entities are MSOs. The term “MSO” also can refer to an operator of one or more satellite television systems.

As used throughout the application, the term “set-top box” or “STB” refers to a receiver or any processing unit that can receive, process, and/or monitor a signal and pass the signal as an audio and video signal to a television or other monitor. The set-top box can be in a separate housing which physically sits on top of a television, it can be in some other location external to the television and in communication with the television, or it can be built into the television itself.

As used throughout the application, the term “time/channel data” refers to data that comprises the time at which a television viewer selects a given channel to be displayed via an STB, the channel selected by the viewer, and the time at which the viewer selects a different channel or turns off the STB. Time/channel data therefore can represent the channel to which an STB is tuned during a time period.

As used throughout the application, the term “programming data” refers to data that represents the television program, or fraction thereof, that was shown via a television viewer's STB.

As used throughout the application, the term “programming guide” refers to a collection of data representing the television programs made available to a given television viewer on multiple channels and during multiple time periods. A programming guide can include a collection of data representing all television programs made available to a given television viewer on all channels during all time periods within a range of time.

As used throughout the application, the term “stored” as it applies to data stored on an STB includes storage of instantaneous, short-term, long-term, or permanent duration. Data “stored” on an STB includes all data processed by the STB, data stored in short-term memory of an STB such as random access memory (RAM), as well as data in long-term or permanent storage of an STB, such as a hard drive.

As used throughout the application, the term “network” includes global computer networks such as the Internet, local computer networks such as Ethernet networks, telephone networks, cable networks, or any other transmission medium suitable for supporting communication between an information processing unit and an MSO, STB, and/or advertiser.

As used throughout the application, the term “sharing preference” refers to the preference of a consumer with respect to sharing data with a ratings provider. In exemplary embodiments described throughout the application, a consumer's “sharing preference” can be in any category 1-5, though sharing preferences need not include these five categories nor be limited to these five categories. A consumer with a category 1 sharing preference is not willing to share any data with a ratings provider. A consumer with a category 2 sharing preference is willing to share periodically the time/channel data stored on the consumer's STB with a ratings provider. A consumer with a category 3 sharing preference is willing to share continuously the time/channel data stored on the consumer's STB with a ratings provider, as well as the consumer's zip code. A consumer with a category 4 sharing preference is willing to share continuously the time/channel data stored on the consumer's STB with a ratings provider, as well as demographic data for one or more members of the consumer's household. A consumer with a category 5 sharing preference is willing to share continuously the time/channel data stored on the consumer's STB with a ratings provider, demographic data for one or more members of the consumer's household, and information indicating the members of the consumer's household that are watching television via the STB at any given time.

The invention enables a ratings provider to provide television ratings based upon data collected from set-top boxes owned by consumers electing to share their viewing information with the ratings provider. According to the invention, these consumers can determine the extent of viewing, identifying, and demographic data shared with the ratings provider.

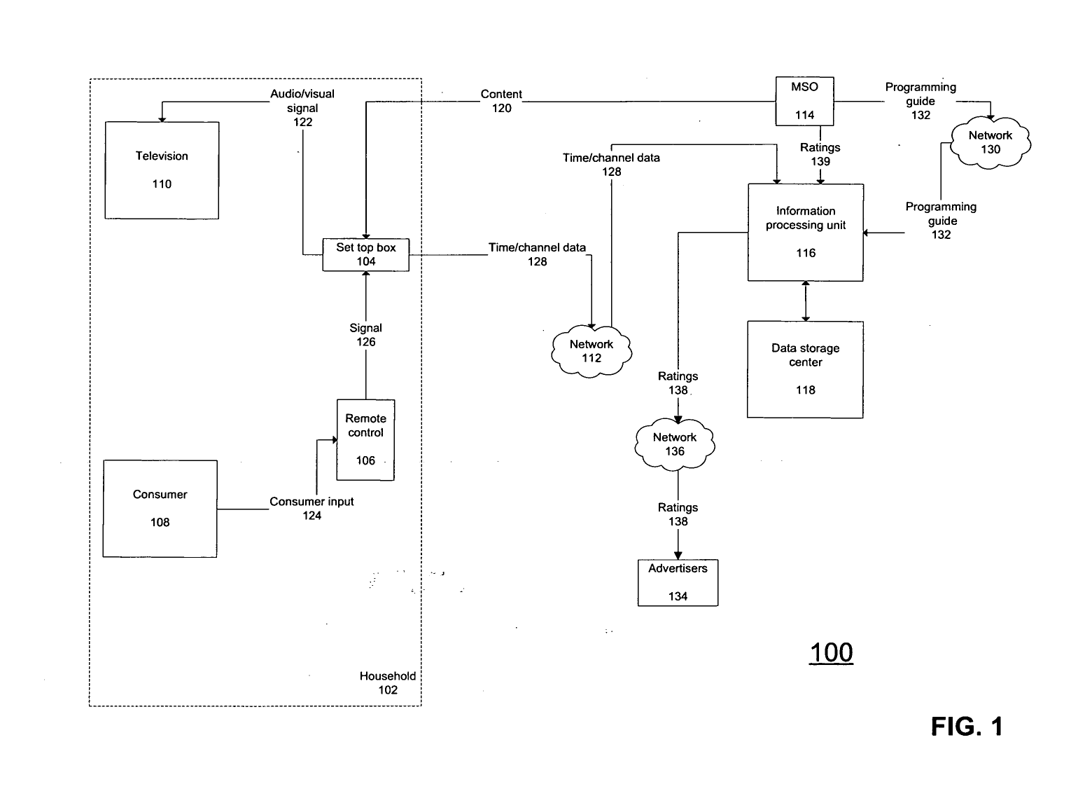

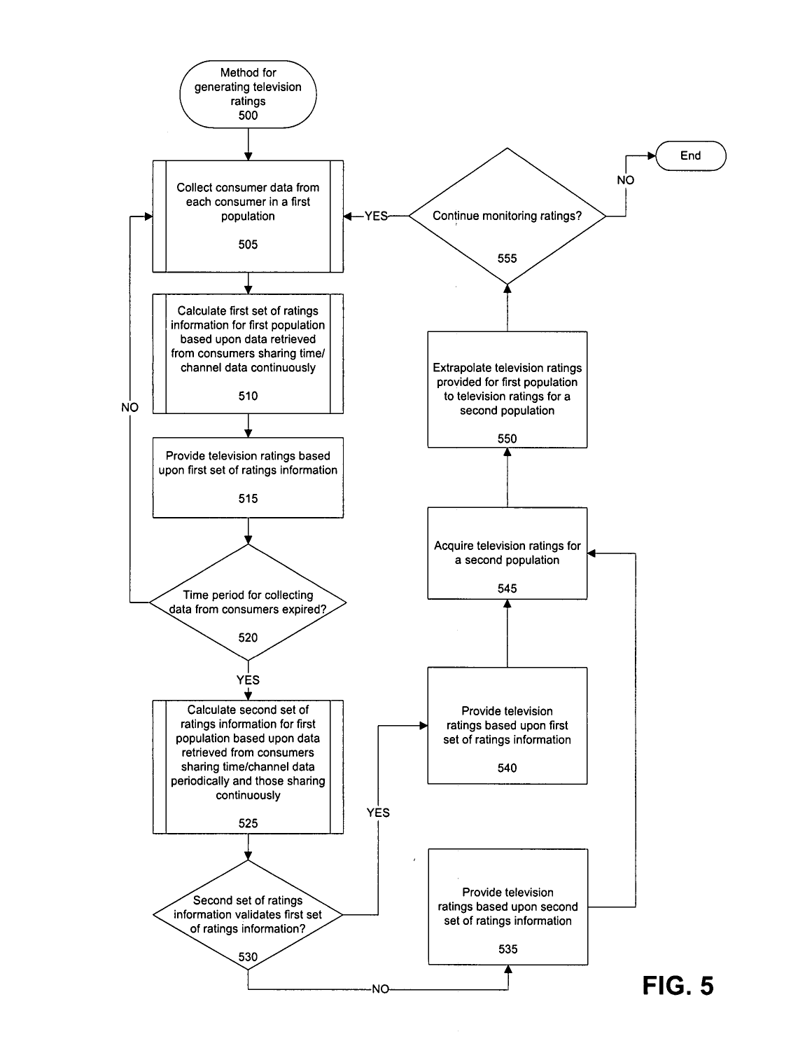

A method and system for providing television ratings will now be described with reference to FIGS. 1-14, which depict representative or illustrative embodiments of the invention. FIGS. 1-4 are block diagrams depicting systems for providing television ratings information based upon data collected from consumers 108 according to exemplary embodiments of the invention. The elements depicted in FIGS. 1-4 will be discussed in more detail hereinafter with reference to the methods illustrated in FIGS. 5-14.

FIG. 5 is a flow chart depicting a method 500 for generating television ratings 138 based upon data collected from multiple consumers 108 according to an exemplary embodiment. The method 500 will be described with reference to FIGS. 1-5.

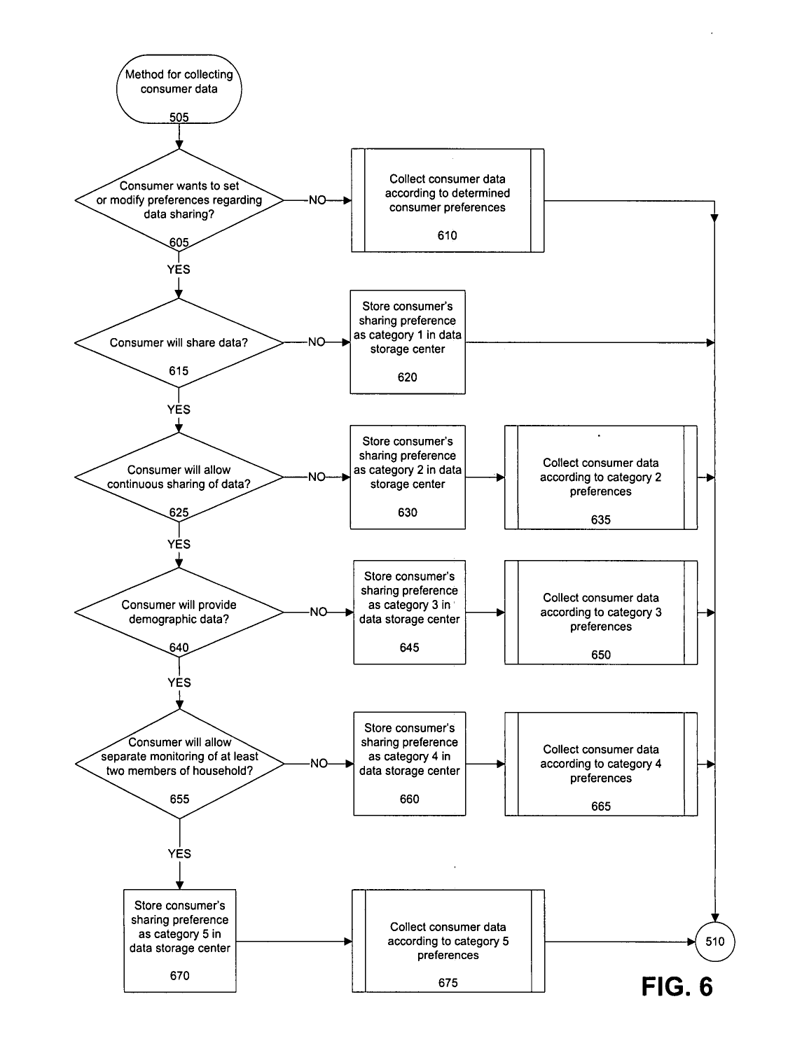

In step 505, data is collected from each consumer 108 in a first population. Exemplary steps of step 505 will be discussed in further detail hereinafter with reference to FIG. 6. In an exemplary embodiment, the first population can include those consumers 108 that own an STB 104. In one exemplary embodiment, consumers 108 can own the data collected from the STBs 104 that they own.

In exemplary embodiments, the data collected from each consumer 108 in the first population can comprise consumer preferences regarding whether or not the consumer desires to share data with a ratings provider, the type of data the consumer wishes to share with a ratings provider, and the frequency at which the consumer wishes to share data with a ratings provider, as well as demographic data and time/channel data 128. Demographic data can correspond with members of the consumer's 108 household 102, and the time/channel data 128 can comprise data indicating the programs watched in the consumer's 108 household 102.

Consumers 108 can watch programs on a television 110, via an STB 104. Content 120 is transmitted from an MSO 114 to an STB 104 owned by the consumer 108. The STB 104 can convert the content 120 to an audio/visual signal 122, and then transmit the audio/visual signal 122 to a television 110, or another display device that can receive an audio/visual signal 122 and present audio and visual output to a consumer 108.

Consumers 108 can send consumer input 124 to the STB 104 via a remote control 106, which receives the input 124 and then sends a signal 126 based upon that input 124 to the STB 104. The STB 104 then receives and processes that signal 126. In exemplary embodiments, consumers 108 can also enter their input 124 directly into the STB 104, without utilizing a remote control 106. In such embodiments, the STB 104 can comprise buttons that enable consumers 108 to enter their input 124, which is then processed by the STB 104.

The consumer input 124 and corresponding signal 126 can comprise a desired channel setting or an indication to turn on or off the STB 104. Upon receiving a signal 126 comprising a desired channel setting entered by the consumer 108, the STB 104 receives content 120 from the MSO 114 corresponding with the desired channel setting. The STB 104 then converts the content 120 corresponding with the desired channel setting to an audio/visual signal 122 and transmits the audio/visual signal 122 to the television 110. Upon receiving a signal 126 comprising an indication to turn on or off the STB 104, the STB 104 will turn its power on or off, respectively.

In exemplary embodiments, time/channel data 128 can be processed by the STB 104, based upon consumer input 124 comprising a desired channel setting or an indication to turn on or off the STB 104, as well as the time the STB 104 processes the signal 126 based upon the consumer input 124. The time/channel data 128 once processed by the STB 104 can be transmitted to an information processing unit 116 via a network 112, if allowed by the consumer's 108 preferences. The consumer's 108 preferences also will dictate whether the time/channel data 128 is to be transmitted continuously or periodically. The aspect of step 505 involving consumer 108 preferences regarding data sharing will be discussed in more detail hereinafter with reference to FIG. 6.

The consumer input 124 and corresponding signal 126 also can comprise consumer 108 preferences regarding data sharing. Upon receiving a signal 126 comprising consumer 108 preferences regarding data sharing, the STB 104 processes the signal 126 and transmits data representing the consumer 108 preferences to an information processing unit 116. The data is then transmitted from the information processing unit 116 to a data storage center 118 where it is stored. In certain embodiments, the STB 104 can transmit the data representing consumer 108 preferences to the information processing unit 116 via a network 112.

Consumer input 124 and the corresponding signal 126 also can comprise demographic data regarding members of the consumer's 108 household 102. The STB 104 can process this demographic data and transmit it to the information processing unit 116 via the network 112. The demographic data then can be transmitted from the information processing unit 116 to the data storage center 118 where it is stored.

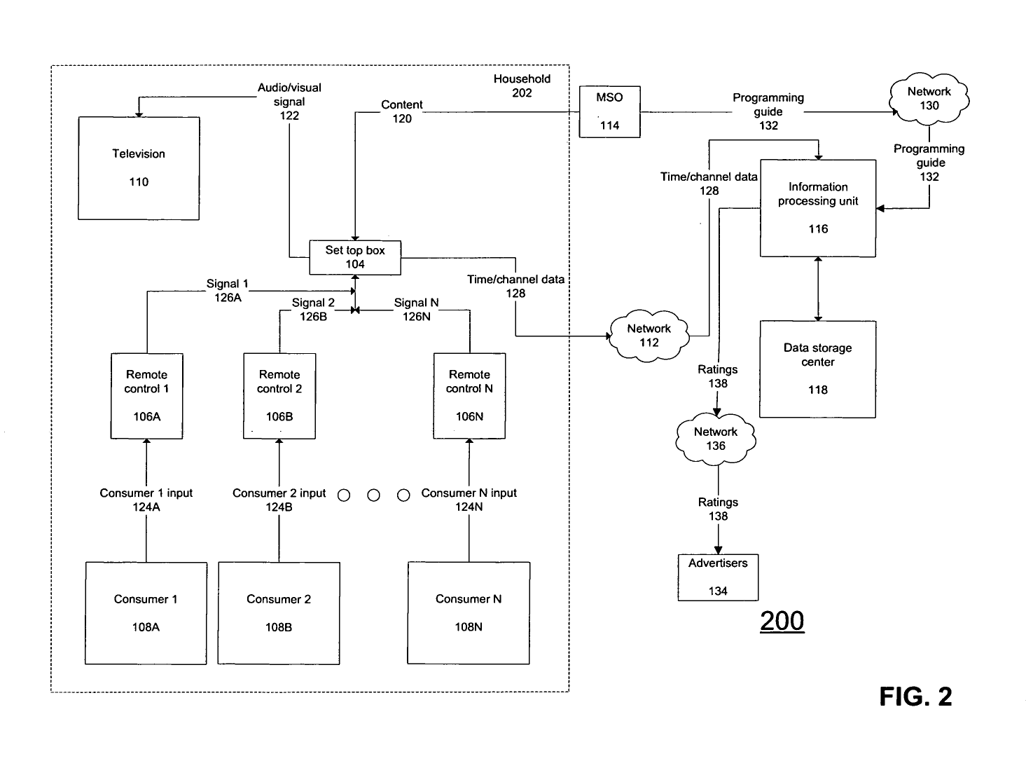

According to step 505 of the method 500, data can be collected from each of multiple consumers 108. In exemplary embodiments, data can be collected from every consumer 108 that owns an STB 104. FIGS. 2-4 illustrate various groups of multiple consumers 108, 308. The elements of FIGS. 2-4 will be discussed with reference to the collection of data from each of multiple consumers 108.

FIG. 2 is a block diagram depicting a system 200 for providing television ratings information based at least partly upon data collected from a household 202 with multiple consumers 108, according to one embodiment of the invention wherein each consumer 108A-N in the household 202 has a unique remote control 106A-N. When collecting data from multiple consumers 108A-N in a household 202, each consumer 108A-N can utilize his or her own remote control 106A-N to enter input 124A-N and send a signal 126A-N to the STB 104 in the household 202. If each consumer 108A-N has a unique remote control 106A-N then the STB 104 can transmit time/channel data 128, or other data such as preferences or demographics, corresponding with the consumer 108A-N that sent the input 124A-N to the STB 104. In an alternative exemplary embodiment, each consumer 108A-N can have a unique remote control 106A-N based on log-in information input via the remote control. In that case, the remote control 106A-N can compare the log-in information with information stored locally or in the data storage center 118 to identify the particular consumer 108A-N.

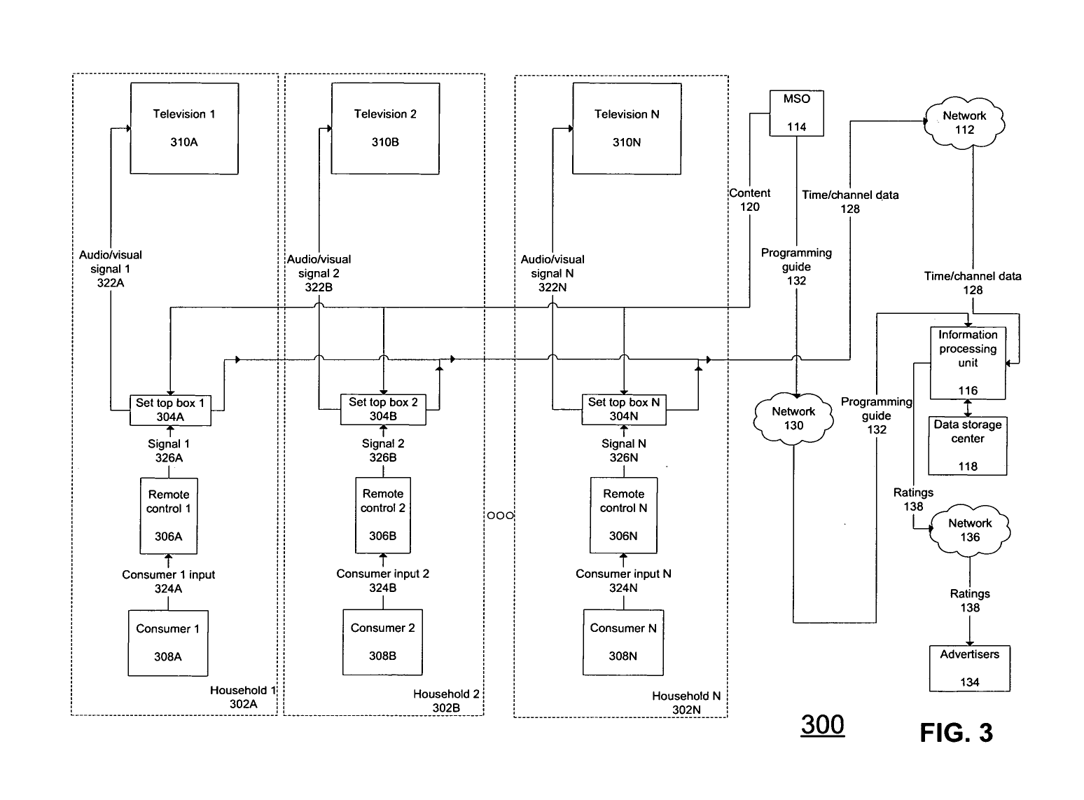

FIG. 3 is a block diagram depicting a system for 300 providing television ratings information based at least partly upon data collected from multiple households 302A-N serviced by an MSO 114, according to an exemplary embodiment. When collecting data from multiple consumers 308A-N in different households 302A-N, each consumer 308A-N can utilize his or her own remote control 306A-N to enter input 324A-N and send a signal 326 A-N to the STB 304A-N in the household 302A-N. Depending on the input 324A-N, the STB 304A-N can change the channel, thereby altering the audio/visual signal 322A-B displayed on the corresponding television 310A-B. Time/channel data 128 also can be processed by the STB 304A-B depending on the input 324A-B. Time/channel data 128, in addition to other data such as preferences or demographics, corresponding with each consumer 308A-N, is transmitted from each STB 304A-N to an information processing unit 116 via a network 112.

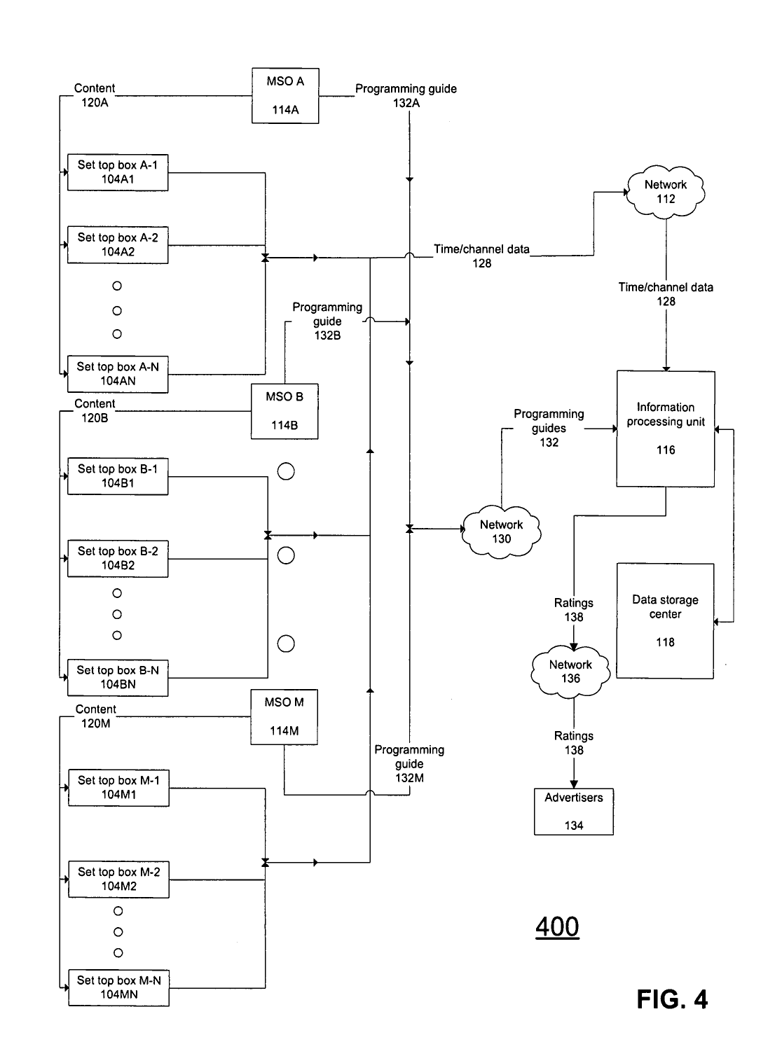

FIG. 4 is a block diagram depicting a system for providing television ratings information based at least partly upon data collected from multiple groups of STBs 104A1-MN, wherein each group of STBs 104A1-MN is serviced by a different MSO 114-M. Although not shown in FIG. 4, each STB 104A1-MN can be located in a different household, and can be owned by a different consumer. In other embodiments, any household can comprise multiple STBs 104A1-MN, and any STB 104A1-MN can be utilized by a plurality of consumers. Time/channel data 128, in addition to other data such as preferences or demographics, corresponding with the consumer that owns each STB 104A1-MN is transmitted to an information processing unit 116 via a network 112.

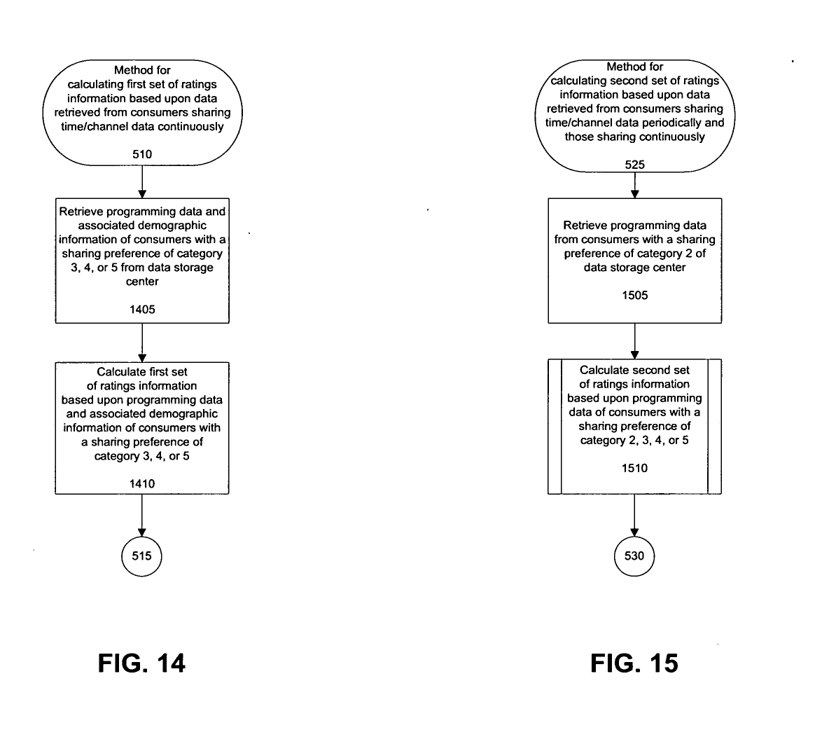

In step 510, a first set of ratings information for the first population is calculated based upon the data retrieved from consumers 108 whose sharing preferences allow time/channel data 128 to be collected at a continuous frequency, as opposed to a periodic frequency. Step 510 will be discussed in more detail hereinafter with reference to FIG. 14.

In step 515, a ratings provider provides television ratings 138 based upon the first set of ratings information that was calculated in step 510. In exemplary embodiments, the ratings provider transmits the television ratings 138 from an information processing unit 116 to advertisers 134 via a network 136. In particular embodiments, the network 136 utilized by a ratings provider in transmitting ratings 138 can be the same network 112 through which time/channel data 128 is transmitted from an STB 104 to the information processing unit 116. For example, both networks 112, 136 can comprise the Internet.

In exemplary embodiments, the advertisers 134 can use the ratings 138 to determine the potential value of airing commercials or product placements during different television programs. Exemplary methods of determining this value can take into account both the number of consumers 108 watching a television program as well as the demographics of the consumers 108 watching the program, both of which can be included as part of the television ratings 138.

In step 520, the method 500 returns to step 505 unless the time period for collecting data from consumers 108 has expired. According to this method 500, data can be collected continuously from all consumers 108 whose sharing preferences allow for data to be collected continuously. Data from those consumers 108 whose sharing preferences allow for data to be collected from their STB 104 periodically will be collected only once the time period for collecting data has expired, and the method 500 proceeds to step 525.

In step 525, a second set of ratings information will be calculated for the first population, based upon the data retrieved from consumers 108 whose sharing preferences allow time/channel data 128 to be collected continuously, as well as upon data retrieved from consumers 108 whose sharing preferences allow time/channel data 128 to be collected periodically. In alternative embodiments, the second set of ratings information can be calculated based upon data retrieved only from those consumers 108 whose sharing preferences allow time/channel data 128 to be collected periodically. Step 525 will be discussed in more detail hereinafter with reference to FIG. 15.

In step 530, the second set of ratings information calculated in step 525 is compared with the first set of ratings information calculated in step 510. In exemplary embodiments, the first and second sets of ratings information are analyzed and compared utilizing statistical methods to determine whether the second set of ratings information is significantly different from the first set. If the two sets are not significantly different, then a ratings provider can conclude that the second set of ratings information validates the first set, and the method 500 proceeds to step 540. If the two sets are significantly different, then a ratings provider can conclude that the second set does not validate the first set, and the method 500 proceeds to step 535.

The first and second sets of ratings information can be derived from different populations of consumers 108. The first set is based upon data collected from consumers 108 whose sharing preferences allow data to be collected from their STBs 104 continuously. The second set is based upon data collected from consumers 108 whose sharing preferences allow data to be collected periodically, and also can be based upon data collected from consumers 108 whose sharing preferences allow data to be collected continuously. If the second set of ratings information validates the first set, then a ratings provider can conclude that the television viewing habits of consumers 108 who are willing to share data continuously are not significantly different from other consumers 108.

In step 535, the ratings provider provides television ratings 138 based upon the second set of ratings information. In alternative embodiments, the ratings provider will not provide any television ratings 138 in step 535. In exemplary embodiments, the ratings provider will not provide television ratings 138 based upon the first set of ratings information in step 535, because step 535 is reached only where the second set of ratings information did not validate the first set. In exemplary embodiments, the ratings provider can transmit the television ratings 138 to advertisers 134 via a network 136 as described previously, and then the advertisers 134 can use the ratings 138 to determine the potential value of airing commercials or product placements as described previously. The method 500 then proceeds to step 545.

Referring back to step 540, the ratings provider provides television ratings 138 based upon the first set of ratings information. In an exemplary embodiment, the ratings provider can extrapolate the demographic data included in the first set of ratings information to the second set of ratings information, and then provide television ratings 138 based on the a combination of the two sets of ratings information. The ratings 138 can include data indicating the number of consumers 108 who watched a television program as well as the demographics of those consumers 108. In exemplary embodiments, the ratings provider can transmit the television ratings 138 to advertisers 134 via a network 136 as described previously. Advertisers 134 then can use the ratings 138 to determine the potential value of airing commercials or product placements during different television programs as described previously.

In step 545, television ratings 139 for a second population are acquired. In an exemplary embodiment, the second population can include consumers 108 that do not own STBs 104. For example, the second population can include those consumers 108 that view programming content 120 from an MSO 114 via an STB 104 owned by the MSO 114. In an exemplary embodiment, the television ratings 139 for the second population can be provided by the MSO 114 to the ratings provider. In an alternative exemplary embodiment, the ratings provider can provide the television ratings 138 for the first population to the MSO 114.

In step 550, television ratings 138 for the first population are extrapolated to the television ratings 139 for the second population that were acquired in step 545. In an exemplary embodiment, this step can include extrapolating demographic data corresponding with the television ratings 138 for the first population to the television ratings 139 for the second population. Those consumers 108 or households 102 in the first population that provide demographic data can be considered the “opt-in consumers.”

In another exemplary embodiment, the television ratings 139 for the second population can include programming information but may not include demographic data corresponding with the programming information. In an alternative exemplary embodiment, the television ratings 139 for the second population can include demographic data, but different types or levels of demographic data from those included with the television ratings 138 for the first population.

In exemplary embodiments, extrapolating television ratings 138 for the first population to the television ratings 139 for the second population can be performed in a variety of methods. Three exemplary methods of extrapolation—Simple Extrapolation, the Inverse Demographic Matrix (“IDM”) Hybrid method, and the Individual Behavior System (“IBS”) Hybrid method—are explicitly disclosed herein. Other suitable methods of extrapolation will be apparent to those having the benefit of this disclosure and may be used to perform step 550.

In an exemplary embodiment, extrapolating television ratings 138 and associated demographic data for the first population to the television ratings 139 for the second population can be performed using Simple Extrapolation. According to the Simple Extrapolation method, the demographic data of the opt-in consumers 108 (i.e., those consumers 108 in the first population that provide demographic data) can be used to compute the relative ratings (that is, the percentage of a program's total rating that comes from each demographic category), while the television ratings 139 from the second population—which can include possibly hundreds of thousands of households—can be used to compute the total rating of every television 110 program (or commercial, or other programming). In an alternative exemplary embodiment, the combination of the first and second populations can be used to compute the total rating.

In other words, the second population (or alternatively, the sum of the first and second populations) is used to compute the total number of consumers 108 or households who are watching a given channel at a given time and date. Due to the large size of this sample, its relatively low bias, and the absence of reporting error, this total number will generally be quite accurate, and then can be used to compute a very accurate estimate of the total rating of a given channel at a given time, across all demographic types. Thus, in an exemplary embodiment, to provide a demographic-specific rating of a given channel at a given time, for a particular demographic type, it is only necessary to determine the number of consumers 108 of the demographic type who are watching the channel at the given time, and divide by the total number of opt-in consumers 108 that indicated they belonged to the demographic type. This ratio then can be multiplied by the total rating for the given channel and time to give the demographic-specific rating for the given channel and time.

In an alternative exemplary embodiment, extrapolating television ratings 138 and associated demographic data for the first population to the television ratings 139 for the second population can be performed using the IDM Hybrid method. A description of a standard IDM algorithm is included in U.S. Pat. No. 7,139,723 to Conkwright et al. (“Conkwright”), the disclosure of which is hereby incorporated herein by reference.

The central step in the IDM algorithm disclosed in Conkwright is minimizing the squared-error function, ψ². Because of statistical fluctuations and demographic measurement errors, it is possible for the IDM algorithm to give results that are less accurate. The IDM Hybrid technique can improve the standard IDM algorithm, as it uses the information from the opt-in households to constrain the solution for the IDM algorithm so that it agrees with the opt-in information within the range of uncertainty of that information.

In an exemplary embodiment, the IDM Hybrid method begins with using viewing information of the opt-in households regarding a particular channel of interest to compute 95% confidence intervals for a demographic-specific viewing probability. When the function ψ² is minimized, these intervals can be used as constraints on the allowed values of the viewing probabilities. Minimization with constraints is a well-studied problem in numerical analysis. In an exemplary embodiment, the Monte Carlo minimization method can be used to minimize the squared-error function. In this way, the advantages of the IDM algorithm—such as the utilization of all of the large sample and inherent bias correction—are retained while at the same time the explicit demographic data from the opt-in households is used to constrain the IDM solution to give reasonable results (i.e., results within the statistical uncertainty of the opt-in data).

In an alternative exemplary embodiment, extrapolating television ratings 138 and associated demographic data for the first population to the television ratings 139 for the second population can be performed using the IBS Hybrid method. The phrase “individual behavior system” or “IBS” is used to refer to audience measurement methods that rely on characterizing individual STBs 104 based on their observed behavior.

In an exemplary embodiment, the IBS Hybrid method includes using an IDM algorithm (such as the IDM algorithm disclosed in Conkwright) to determine probabilities of demographic groups watching a given television channel at a given time, and then correlating the behavior of individual STBs 104 with those probabilities to assign presumed demographic descriptors to the people controlling the STBs 104. Thus, the IBS Hybrid method can include a comparison between the behavior of the opt-in consumers 108 and the individual STBs 104 in the full sample (i.e., either the second population or the first and second populations combined).

In an exemplary embodiment, the IBS Hybrid method can begin by defining a “behavior similarity index,” bᵢⱼ, between two STBs 104 identified as STB i and STB j. This index measures how closely the historical behavior of STB i matches that of STB j, and is defined as
bᵢⱼ=Σδ(sᵢ(t),sⱼ(t))/Nₜ,
where sᵢ(t) is the state (channel) of STB i at time t, the sum is over Nₜ time intervals of a given duration (a second, minute, hour, etc.), and δ(x,y) is the Kronecker delta, defined to be 1 if x=y, otherwise 0. As defined, bᵢⱼ is a number between 0 and 1, with its value being zero if the two STBs 104 are never on the same channel at the same time (during the defined time period), or being equal to 1 if the two STBs 104 are always on the same channel at the same time during the time interval. More generally, bᵢⱼ can measure how similar the behavior of the two STBs 104 is.

In an exemplary embodiment, the IBS Hybrid method can include computing the behavior similarity index for each STB i that is not owned by an opt-in consumer 108 with respect to each STB j that is owned by an opt-in consumer 108. The values thus obtained are measures of the similarity in viewing habits between each opt-in consumer's 108 STB 104 and all other STBs 104. These values then can be used as weights in a weighted average over all demographic categories, in which each term is equal to bᵢⱼ times the demographic value of STB j (which is known for the opt-in households) in each demographic category. In this way, an assumed demographic description, which can include fractions of various demographic descriptions, can be assigned to each of the non-opt-in STBs 104. The demographic-specific rating of a given channel and time then can be computed simply by adding together the number of STBs 104 (or fraction thereof) on that channel for each demographic specification.

In step 555, if the television ratings monitoring is to continue, the method 500 returns to step 505. Otherwise, the method 500 will end.

FIG. 6 is a flow chart depicting a method 505 for collecting consumer 108 data, as referenced in step 505 of FIG. 5. The method 505 will be described with reference to FIGS. 1 and 6. As discussed, the method 505 can be performed for each of multiple consumers 108.

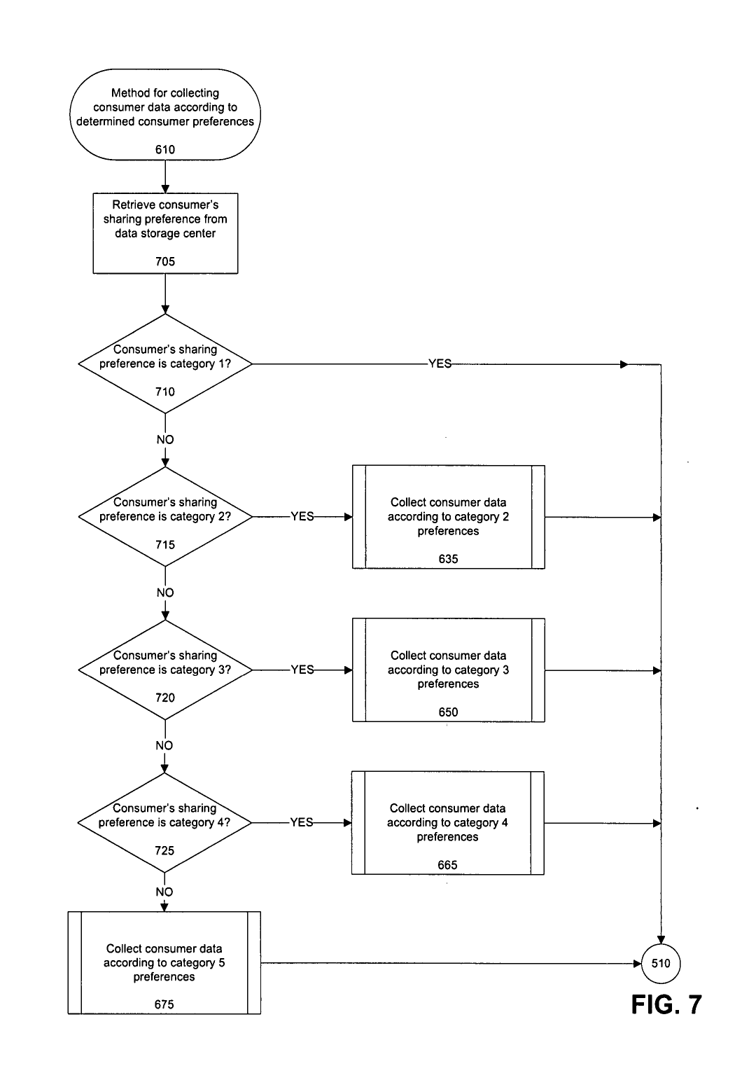

In step 605, the method 505 determines whether the consumer 108 wants to set or modify preferences regarding data sharing. If the consumer 108 does not want to set or modify the preferences, the method 505 proceeds to step 610, where consumer 108 data will be collected according to the preferences already determined by the consumer 108. Step 610 will be discussed in more detail hereinafter with reference to FIG. 7. After step 610, the method 505 proceeds to step 510 (FIG. 5).

Referring back to step 605, if the consumer 108 does want to set or modify the preferences regarding data sharing in step 605, the method 505 proceeds to step 615 and determines whether the consumer 108 will share data from his or her STB 104. If the consumer 108 will not share data, the method 505 proceeds to step 620, where the consumer's 108 sharing preference is stored as category 1 in a data storage center 118, and then the method 505 proceeds to step 510 (FIG. 5). Consumers 108 with a sharing preference of category 1 are therefore those who will not share any data from their STBs 104.

Referring back to step 615, if the consumer 108 will share data from his or her STB 104, the method 505 proceeds from to step 625 and determines whether the consumer 108 will allow continuous sharing of data. If the consumer 108 will not allow continuous sharing of data, the method 505 proceeds to step 630, where the consumer's 108 sharing preference is stored as category 2 in a data storage center 118, and then the method 505 proceeds to step 635 where consumer 108 data will be collected according to category 2 preferences. Consumers 108 with a sharing preference of category 2 are therefore those who will share data from their STBs 104 only periodically.

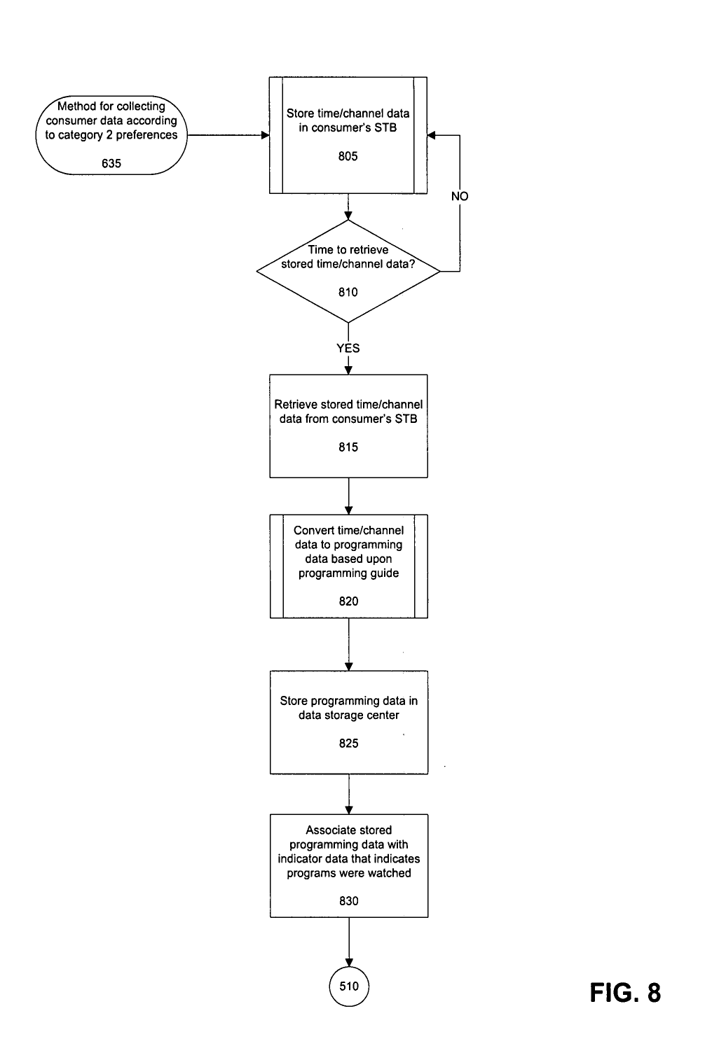

In exemplary embodiments, the time period for collecting such data from consumers 108 with a sharing preference of category 2 can be the time period referenced in step 520 of FIG. 5, and its value can be any suitable period of time that does not provide continuous data. For example, in different embodiments, data could be collected from consumers 108 with a sharing preference of category 2 once each week, month, quarter, or year. After step 635, which will be discussed in more detail hereinafter with reference to FIG. 8, the method 505 proceeds to step 510 (FIG. 5).

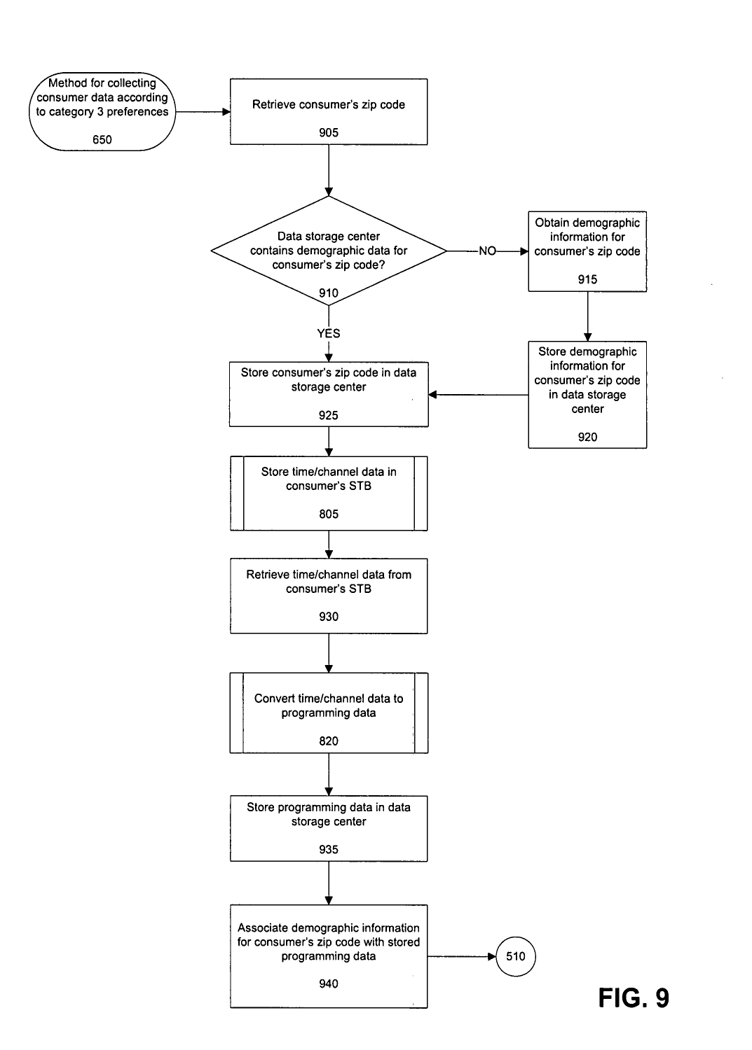

Referring back to step 625, if the consumer 108 will allow continuous sharing of data from his or her STB 104, the method 505 proceeds to step 640 and determines whether the consumer 108 will provide any demographic data about at least one member of the consumer's 108 household 102. If the consumer 108 will not provide any demographic data, the method 505 proceeds to step 645, where the consumer's 108 sharing preference is stored as category 3 in a data storage center 118, and then the method 505 proceeds to step 650 where consumer 108 data will be collected according to category 3 preferences. Consumers 108 with a sharing preference of category 3 are therefore those who will share data from their STBs 104 continuously, but will not share demographic data. In an exemplary embodiment, consumers 108 with a category 3 sharing preference can share their zip code with a ratings provider. Thus, such consumers 108, along with those with a category 4 or category 5 sharing preference, can be considered “opt-in” consumers 108, in that they have agreed to provide at least some data in addition to the time/channel data 128 that can be used to associate the time/channel data 128 with demographic data. After step 650, which will be discussed in more detail hereinafter with reference to FIG. 9, the method 505 proceeds to step 510 (FIG. 5).

In exemplary embodiments, the opt-in consumers 108 can play a significant role in providing ratings information. It is important to note that the opt-in consumers 108 are not opting in to any additional monitoring, in that their STB 104 channel changes can be recorded in the same way as other digital cable subscribers. They are only agreeing to provide some demographic data, ranging from their zip code to more detailed demographic data, and agreeing to have that information correlated with their STB 104. For this reason, recruitment bias may be less than it is for non-passive audience measurement techniques.

In an exemplary embodiment, each STB 104 can be assigned a unique STB 104 identifier. Then, the demographic data of the consumer 108 that owns that STB 104 also can be associated with the STB 104 identifier, so that the consumer's 108 demographic data can be later associated with the time/channel data 128 yielded from the STB 104.

In another exemplary embodiment, a household 102 that includes multiple consumers 108 (such as a family) can own an STB 104 jointly. In such households 102, a representative or “head” of the household 102 can consent to provide demographic data (as well as providing time/channel data 128). Such consent can remove or reduce legal obstacles to combining the demographic data with the unique identifier of the household's 102 STB 104.

In another exemplary embodiment, demographic data for the opt-in consumers 108 can be reviewed to ensure that the opt-in consumers 108 collectively comprise a fair cross-section of the television viewing population. For example, the opt-in consumers 108 can include consumers 108 from a large range of demographic types, and may or may not be random.

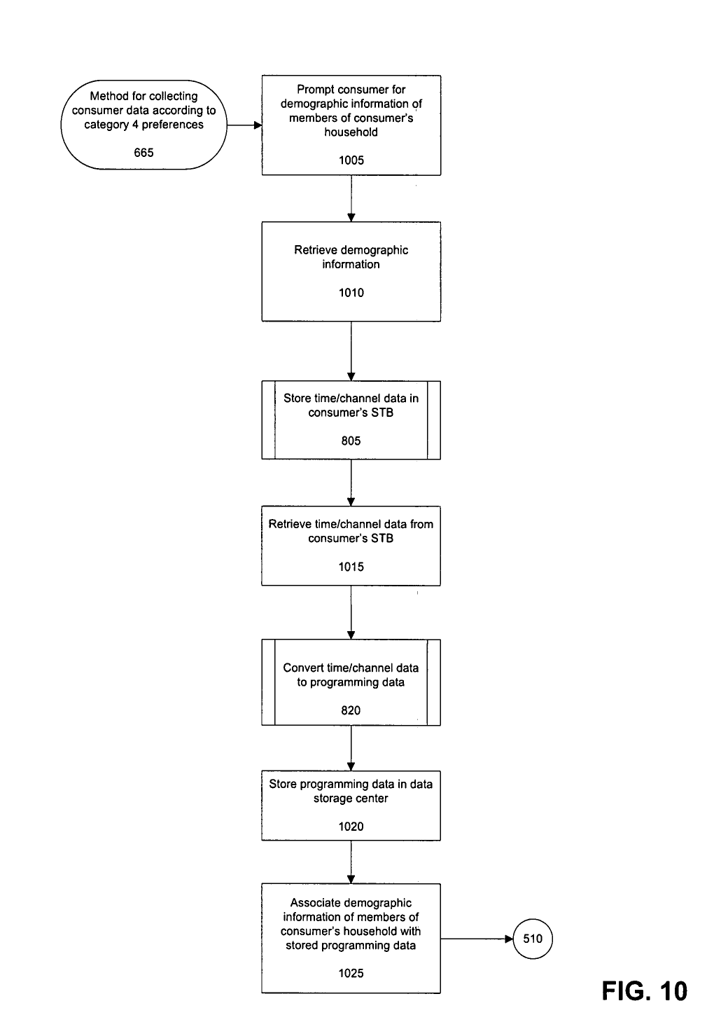

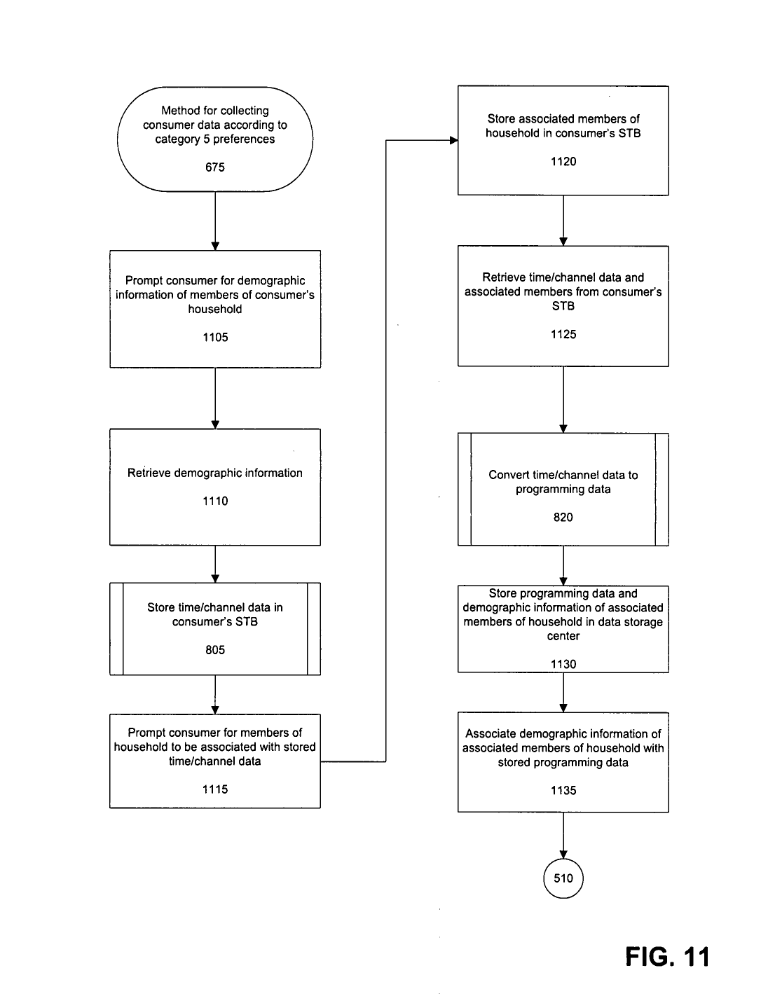

Referring back to step 640, if the consumer 108 will provide demographic data, the method 505 proceeds to step 655 and determines whether the consumer 108 will allow separate monitoring of at least two members of the household 102. By “separate monitoring of at least two members of the household,” it is meant that the consumer 108 allows the time/channel data 128 retrieved from the STB 104 to be associated with specific members of the household 102 watching the television 110 during the time period included in the time/channel data 128. Various methods exist for such separate monitoring, with an exemplary method being discussed in more detail hereinafter with reference to FIG. 11. If the consumer 108 does not allow separate monitoring of at least two members of the household 102, the method 505 proceeds to step 660, where the consumer's 108 sharing preference is stored as category 4 in a data storage center 118, and then the method 505 proceeds to step 665, where consumer 108 data will be collected according to category 4 preferences. Consumers 108 with a sharing preference of category 4 are therefore those who will share data from their STBs 104 continuously and provide demographic data, but will not allow separate monitoring of at least two members of the household 102. After step 665, which will be discussed in more detail hereinafter with reference to FIG. 10, the method 505 proceeds to step 510 (FIG. 5).

Referring back to step 655, if the consumer 108 will allow separate monitoring of at least two members of the household 102, the method 505 proceeds to step 670, where the consumer's 108 sharing preference is stored as category 5 in a data storage center 118. The method 505 will then proceed to step 675, where consumer 108 data will be collected according to category 5 preferences. Consumers 108 with a sharing preference of category 5 are therefore those who will share data from their STBs 104 continuously, provide demographic data, and allow separate monitoring of at least two members of the household 102. After step 675, which will be discussed in more detail hereinafter with reference to FIG. 11, the method 505 proceeds to step 510 (FIG. 5).

Various procedures exist for making the determinations of consumer 108 preferences disclosed in steps 605, 615, 625, 640, and 655. In certain embodiments of the invention, a prompt can appear on the STB 104 or on the television 110, asking the consumer 108 for his or her preferences. In certain embodiments, the consumer 108 can enter input 124 comprising a response to the prompt via a remote control 106, which will send a corresponding signal 126 to the STB 104, where the signal 126 can be processed to determine the consumer's 108 preferences. In alternative embodiments of the invention, the method 505 can determine consumer 108 preferences by providing a network interface, such as a website, where the consumer 108 can enter his or her preferences regarding data sharing. In any of these embodiments, the consumer 108 also can enter identifying data, associating his or her preferences with his or her STB 104.

Regardless of the procedure utilized by the method 505 for determining consumer 108 preferences, the preferences once determined can be retrieved by an information processing unit 116 and then transmitted to a data storage center 118 where they can be stored.

FIG. 7 is a flow chart depicting a method 610 for collecting consumer 108 data according to consumer 108 preferences that have already been determined, as referenced in step 610 of FIG. 6. The method 610 will be described with reference to FIGS. 1 and 7.

In step 705, the method 610 retrieves the consumer's 108 sharing preference from a data storage center 118. As discussed, a consumer's 108 sharing preference can comprise a category that indicates the amount and/or frequency of data sharing the consumer 108 will allow. In exemplary embodiments, the preference can be retrieved with an information processing unit 116.

In step 710, the method 610 determines whether the consumer's 108 sharing preference is category 1. If the consumer's 108 sharing preference is category 1, the method 610 proceeds to step 510 (FIG. 5). If the consumer's 108 sharing preference is not category 1, the method 610 proceeds to step 715.

In step 715, the method 610 determines whether the consumer's 108 sharing preference is category 2. If the consumer's 108 sharing preference is category 2, the method 610 proceeds to step 635 where, as shown in FIG. 6, consumer 108 data will be collected according to category 2 preferences. Step 635 will be described in more detail hereinafter with reference to FIG. 8. After step 635, the method 610 proceeds to step 510 (FIG. 5). Referring back to step 715, if the consumer's 108 sharing preference is not category 2, the method 610 proceeds to step 720.

In step 720, the method 610 determines whether the consumer's 108 sharing preference is category 3. If the consumer's 108 sharing preference is category 3, the method 610 proceeds to step 650 where, as shown in FIG. 6, consumer 108 data will be collected according to category 3 preferences. Step 650 will be described in more detail hereinafter with reference to FIG. 9. After step 650, the method 610 proceeds to step 510 (FIG. 5). Referring back to step 720, if the consumer's 108 sharing preference is not category 3, the method 610 proceeds to step 725.

In step 725, the method 610 determines whether the consumer's 108 sharing preference is category 4. If the consumer's 108 sharing preference is category 4, the method 610 proceeds to step 665 where, as shown in FIG. 6, consumer 108 data will be collected according to category 4 preferences. Step 665 will be described in more detail hereinafter with reference to FIG. 10. After step 665, the method 610 proceeds to step 510 (FIG. 5).

Referring back to step 725, if the consumer's 108 sharing preference is not category 4, the method 610 proceeds to step 675 where, as shown in FIG. 6, consumer 108 data will be collected according to category 5 preferences. Consumer 108 data can be collected according to category 5 preferences because the method 610 determined that the consumer 108 sharing is not category 1, 2, 3, or 4. Step 675 will be described in more detail hereinafter with reference to FIG. 11. After step 675, the method 610 proceeds to step 510 (FIG. 5).

FIG. 8 is a flow chart depicting a method 635 for collecting consumer 108 data according to category 2 preferences, as referenced in step 635 of FIG. 6. The method 635 will be described with reference to FIGS. 1 and 8.

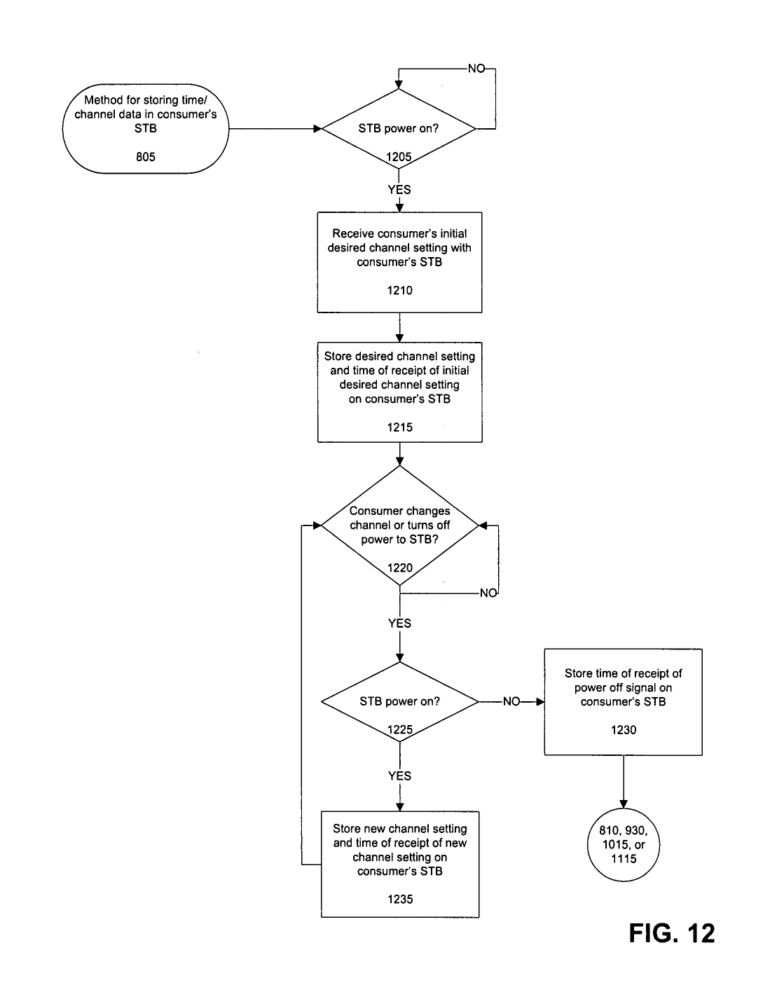

In step 805, the time/channel data 128 is stored in the consumer's 108 STB 104. Time/channel data 128, as discussed previously, indicates the time period during which the STB 104 was tuned to a given channel. Various methods for storing time/channel data 128 in an STB 104 are suitable, one example of which is discussed in more detail hereinafter with reference to FIG. 12.

In step 810, the method 635 determines whether the current time is the time to retrieve time/channel data 128 stored on the STB 104. If the current time is not yet the time to retrieve time/channel data 128, the method 635 returns to step 805, thereby continuing to store time/channel data 128. The time to retrieve time/channel data 128 from STBs 104 owned by consumers 108 with a category 2 sharing preference can depend upon the time period discussed in step 520 of FIG. 5. For example, if data is to be collected from consumers 108 with a sharing preference of category 2 every six months, then the time to retrieve stored time/channel data 128 can occur once every six months. Once the current time is the time to retrieve time/channel data 128 from an STB 104 owned by a consumer 108 with a category 2 sharing preference, the method 635 proceeds to step 815.

In step 815, the time/channel data 128 stored in the consumer's 108 STB 104 is retrieved from the STB 104. In exemplary embodiments, the time/channel data 128 can be retrieved with an information processing unit 116 via a network 112. The network 112 utilized in retrieving the time/channel data 128 can be any network that can transmit data from an STB 104 to an information processing unit 116. In exemplary embodiments, the network 112 can be the Internet.

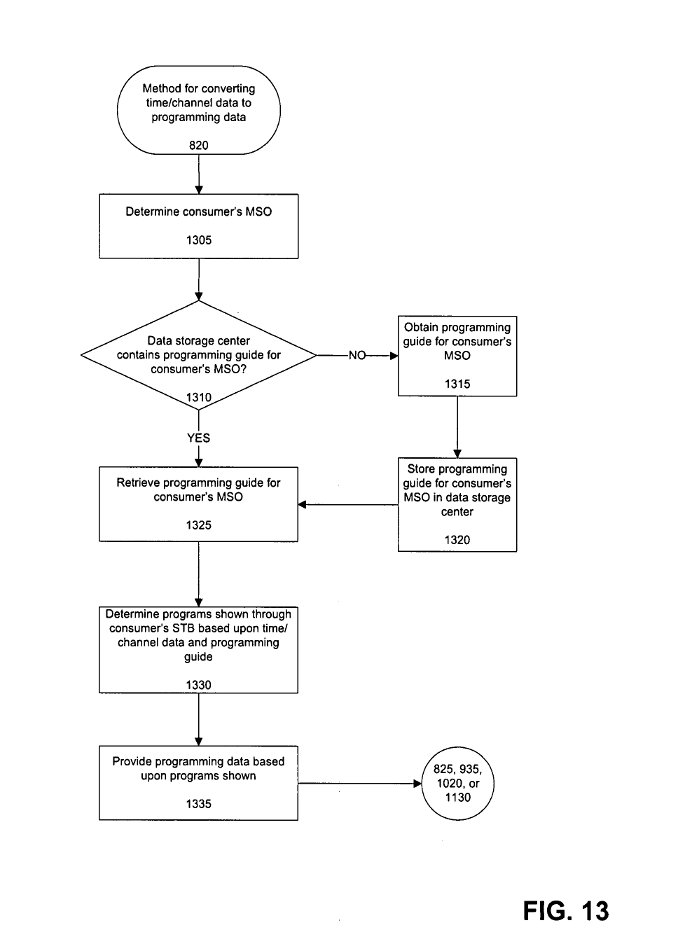

In step 820, the time/channel data 128 is converted to programming data based upon a programming guide 132. The programming data generated can indicate the program, or fraction thereof, watched by the consumer 108. Various methods can be utilized for converting time/channel data 128 to programming data, and one such method is described in more detail hereinafter with reference to FIG. 13. In exemplary embodiments, the conversion in step 820 can be performed utilizing an information processing unit 116 that has retrieved a programming guide 132 that indicates the programs aired on any channel, at any time, and that can be received as content 120 by the consumer's 108 STB 104.

In step 825, the programming data is stored in a data storage center 118. In exemplary embodiments, the programming data is transmitted to the data storage center 118 from an information processing unit 116.

In step 830, the programming data is stored in the data storage center 118 is associated with indicator data. The indicator data can be any data that can be associated with programming data and can indicate that the programs corresponding with the programming data were watched in a household 102. The indicator data need not identify the particular consumer 108, household 102, or STB 104 from which the time/channel data 128 corresponding with the programming data originated. In exemplary embodiments, however, indicator data also can comprise data that identifies the particular consumer 108, household 102, and/or STB 104, as long as the consumer 108 allows for such identifying data. In exemplary embodiments, the consumer 108 can provide further demographic data to be associated with the programming data if the consumer 108 wishes to do so. The method 635 then proceeds to step 510.

FIG. 9 is a flow chart depicting a method 650 for collecting consumer 108 data according to category 3 preferences, as referenced in step 650 of FIG. 6. The method 650 will be described with reference to FIGS. 1 and 9.

In step 905, the consumer's 108 zip code is retrieved. In certain embodiments, the consumer 108 can provide his or her zip code. The consumer 108 can provide the zip code by several different methods, as described previously, including utilizing the remote control 106 to send a signal 126 to the STB 104 or utilizing a web page. The zip code then can be retrieved by the information processing unit 116. In other embodiments, the MSO 114 to which the consumer 108 subscribes can provide the consumer's 108 zip code, by transmitting the zip code to the information processing unit 116 via a network 130.

In step 910, the method 650 determines whether the data storage center 118 already comprises demographic data for the consumer's 108 zip code. If the data storage center 118 does not already comprise the demographic data of the consumer's 108 zip code, the method 650 proceeds to step 915, where the demographic data for the zip code is obtained.

In certain embodiments, demographic data of a given zip code can be obtained from organizations that track demographics by zip code, such as the United States Census Bureau. In exemplary embodiments, the demographic data can be retrieved with an information processing unit 116 and then transmitted to a data storage center 118.

In step 920, the demographic data for the consumer's 108 zip code is stored in the data storage center 118. The method 650 then proceeds to step 925. The method 650 also proceeds directly to step 925 from step 910 if the data storage center 118 already comprises demographic data for the consumer's 108 zip code.

In step 925, the consumer's 108 zip code is stored in the data storage center 118. The method 650 then proceeds to step 805, where time/channel data 128 is stored in the consumer's 108 STB 104. As discussed previously, step 805 is described in more detail hereinafter with reference to FIG. 12. The method 650 then proceeds to step 930.

In step 930, the time/channel data 128 stored in the consumer's 108 STB 104 is retrieved from the STB 104. As discussed previously, in exemplary embodiments, the time/channel data 128 can be retrieved with an information processing unit 116 via a network 112 such as the Internet. The method 650 then proceeds to step 820.

In step 820, as discussed previously, the time/channel data 128 is converted to programming data based upon a programming guide 132. Various methods can be utilized for converting time/channel data 128 to programming data, and one such method is described in more detail hereinafter with reference to FIG. 13. The method 650 then proceeds to step 935.

In step 935, the programming data is stored in the data storage center 118. In exemplary embodiments, the programming data can be transmitted to the data storage center 118 from an information processing unit 116.

In step 940, the programming data stored in the data storage center 118 is associated with the demographic data of the consumer's 108 zip code that was stored in the data storage center 118 in step 925. In certain embodiments, the programming data also can be associated with indicator data that indicates the programs were watched in a household 102.

In exemplary embodiments, associating the demographic data of the consumer's 108 zip code with the programming data can comprise utilizing statistical methods to estimate demographic data of the “typical” or average consumer 108 residing in the zip code. For example, data could be collected from a consumer 108 with a category 3 sharing preference, located within a zip code where demographic data indicates that 50% of the consumers 108 are under age 40, 25% are between 40 and 60, and 25% are over age 60. In this example, the demographic data associated with the programming data can comprise one-half of a consumer 108 under the age of 40, one-fourth of a consumer 108 between ages 40 and 60, and one-fourth of a consumer 108 over age 60. In the long run, as data is collected from all consumers 108, such fractions of consumers 108 can be aggregated to represent estimations of the demographics of consumers 108 associated with programming data.

In an alternative embodiment, associating the demographic data of the consumer's 108 zip code with the programming data can comprise one or more of the methods, systems, and/or teachings of U.S. patent application Ser. No. 10/282,069, filed Oct. 29, 2002, published Sep. 11, 2003, and entitled “Content Reaction Display,” the disclosure of which is hereby incorporated herein by reference. In another exemplary embodiment, associating the demographic data of the consumer's 108 zip code with the programming data can comprise one or more of the methods, systems, and/or teachings of U.S. patent application Ser. No. 10/241,841, filed Sep. 12, 2002, published Aug. 7, 2003, and entitled “Event Invalidation Method,” the disclosure of which is hereby incorporated herein by reference.

After associating the demographic data of the consumer's 108 zip code with stored programming data, the method 650 proceeds to step 510 (FIG. 5).

FIG. 10 is a flow chart depicting a method 665 for collecting consumer 108 data according to category 4 preferences, as referenced in step 665 of FIG. 6. The method 665 will be described with reference to FIGS. 1 and 10.

In step 1005, the consumer 108 is prompted for demographic data of the members of consumer's 108 household 102. The consumer 108 can enter the number of members of the household 102 and can enter demographic data for one or more these members.

In alternative embodiments of the invention, various methods exist for prompting the consumer 108 for such information. For example, the prompt can be displayed on a television 110 via the STB 104, and then the consumer 108 could utilize the remote control 106 to input 124 the demographic data. Alternatively, the consumer 108 could be prompted for demographic data via a website.

In step 1010, the demographic data entered by the consumer 108 is retrieved. In particular embodiments, the demographic data can be retrieved with an information processing unit 116 via a network 112.

The method 665 then proceeds to step 805, where time/channel data 128 is stored in the consumer's 108 STB 104. As discussed previously, step 805 is described in more detail hereinafter with reference to FIG. 12. The method 665 then proceeds to step 1015.

In step 1015, the time/channel data 128 stored in the consumer's 108 STB 104 is retrieved from the STB 104. As discussed previously, in exemplary embodiments, the time/channel data 128 can be retrieved with an information processing unit 116 via a network 112 such as the Internet. The method 665 then proceeds to step 820.

In step 820, as discussed previously, the time/channel data 128 is converted to programming data based upon a programming guide 132. Various methods can be utilized for converting time/channel data 128 to programming data, and one such method is described in more detail hereinafter with reference to FIG. 13. The method 665 then proceeds to step 1020.

In step 1020, the programming data is stored in the data storage center 118. In exemplary embodiments, the programming data is transmitted to the data storage center 118 from an information processing unit 116.

In step 1025, the programming data stored in the data storage center 118 is associated with the demographic data of the members of consumer's 108 household 102. In exemplary embodiments, the demographic data can be the information that was entered by the consumer 108 and retrieved in step 1010. In certain embodiments, the programming data also can be associated with indicator data that indicates the programs were watched in a household 102.

In exemplary embodiments, associating the demographic data of the members of the consumer's 108 household 102 with the programming data can comprise utilizing statistical methods known in the art to estimate demographic data of the “typical” or average member of the household 102. For example, data could be collected from the STB 104 of a consumer 108 who entered demographic data that indicated that the consumer's 108 household 102 comprises 2 members: a 50-year old male and a 40-year old female. Any programming data based upon time/channel data 128 retrieved from an STB 104 in this consumer's 108 household 102 could be associated with one-half of a 50-year old male consumer 108 and one-half of a 40-year old female consumer 108. In the long run, as data is collected from all consumers 108, such fractions of consumers 108 can be aggregated to represent estimations of the demographics of consumers 108 associated with programming data.

FIG. 11 is a flow chart depicting a method 675 for collecting consumer 108 data according to category 5 preferences, as referenced in step 675 of FIG. 6. The method 675 will be described with reference to FIGS. 1, 2 and 11.

In step 1105, the consumer 108 is prompted for demographic data of the members of consumer's 108 household 102. The consumer 108 can enter the number of members of the household 102 and can enter demographic data for one or more these members.

In alternative embodiments of the invention, various methods exist for prompting the consumer 108 for such information. For example, the prompt can be displayed on a television 110 via the STB 104, and then the consumer 108 could utilize the remote control 106 to input 124 the demographic data. Alternatively, the consumer 108 could be prompted for demographic data via a website.

In step 1110, the demographic data entered by the consumer 108 is retrieved. In particular embodiments, the demographic data can be retrieved with an information processing unit 116 via a network 112.

The method 675 then proceeds to step 805, where time/channel data 128 is stored in the consumer's 108 STB 104. As discussed previously, step 805 is described in more detail hereinafter with reference to FIG. 12. The method 675 then proceeds to step 1115.

In step 1115, the consumer 108 is prompted to indicate the members of the household 102 to be associated with the time/channel data 128 stored in the STB 104 in step 805. Any of the various methods for prompting the consumer 108 for information discussed previously can be utilized to prompt the consumer 108 to indicate these associated members of the household 102.

Although this step 1115 is shown in FIG. 11 as being performed after the time/channel data 128 is stored in the STB 104, this step can be performed at any of several different times. In some embodiments, step 1115 can be performed whenever the STB's 104 power is turned on or an initial channel is selected by a consumer 108 to be displayed on the television 110 via the STB 104. In these embodiments, the consumer 108 can be prompted for the members of the household 102 presently viewing the television 110. In other embodiments, the step 1115 can be performed when a subsequent channel is selected or when the STB 104 is powered off. In these embodiments, the consumer 108 can be prompted for the members of the household 102 that were viewing the television 110 before the channel was changed or the STB 104 was powered off.

In particular embodiments, prompting the consumer 108 to indicate the members of the household 102 to be associated with time/channel data 128 can be performed implicitly. For example, FIG. 2 shows a household 202 comprising multiple consumers 108A-N, each with a unique remote control 106A-N. When one of the unique remote controls 106A-N transmits a signal 126A-N to the STB 104, the STB 104 can determine which of the remote controls 106A-N sent the signal 126, as well as the associated consumer 108A-N. Therefore, if consumer 2 108B utilizes remote control 2 106B to set the channel to 5 at 12:30 pm, and then utilizes remote control 2 106B to turn off the STB 104 at 1:30 pm, the STB 104 can determine that consumer 2 108B watched channel 5 from 12:30 pm to 1:30 pm.

Regardless of how the consumer 108 is prompted for these associated members of the household 102, the method 675 then proceeds to step 1120. In step 1120, the associated members of the household 102 are stored in the consumer's 108 STB 104.

In step 1125, the time/channel data 128 stored in the consumer's 108 STB 104 is retrieved from the STB 104, along with the associated members of the household 102. As discussed previously, in exemplary embodiments, the time/channel data 128, as well as the associated members, can be retrieved with an information processing unit 116 via a network 112 such as the Internet. The method 675 then proceeds to step 820.

In step 820, as discussed previously, the time/channel data 128 is converted to programming data based upon a programming guide 132. Various methods can be utilized for converting time/channel data 128 to programming data, and one such method is described in more detail hereinafter with reference to FIG. 13. The method 675 then proceeds to step 1130.

In step 1130, the programming data and the demographic data of the associated members of the household 102 are stored in the data storage center 118. In exemplary embodiments, the demographic data of the members of the household 102 retrieved in step 1110 is correlated with the associated members of the household 102 retrieved in step 1125 to determine demographic data of the associated members of the household 102. In certain embodiments, the programming data and demographic data can be transmitted from an information processing unit 116 to the data storage center 118 for storage.

In step 1135, the programming data stored in the data storage center 118 is associated with the demographic data of the associated members of the consumer's 108 household 102. In certain embodiments, the programming data also can be associated with indicator data that indicates the programs were watched in a household 102.

FIG. 12 is a flow chart depicting a method 805 for storing time/channel data 128 in a consumer's 108 STB 104, as referenced by step 805 of FIGS. 8, 9, 10, and 11. The method 805 will be described with reference to FIGS. 1 and 12.

In step 1205, the method 805 determines if the STB's 104 power is on. If the power is not on, then the step 1205 repeats itself. Once the power is turned on, the method 805 proceeds to step 1210.

In step 1210, the STB 104 receives the consumer's 108 initial desired channel setting. In certain embodiments, the consumer's 108 initial desired channel setting can be input 124 into the remote control 106, which then sends a corresponding signal 126 to the STB 104.

In step 1215, the initial desired channel setting and the time of receipt of the initial desired channel setting are stored on the STB 104. In exemplary embodiments, if the consumer 108 does not enter an initial desired channel setting, then the channel to which the STB 104 is tuned upon being turned on can be substituted for the initial desired channel setting, and the time that the STB's 104 power was turned on can be substituted for the time of receipt of the initial desired channel setting stored on the STB 104.

In step 1220, the method 805 determines if the consumer 108 has changed the channel on the STB 104 or turned the power to the STB 104 off. In certain embodiments, this determination can be made by determining if the STB 104 has received a signal 126 corresponding with consumer input 124 indicating a desire to change the channel on the STB 104 or turn the STB 104 off. If neither action has been taken by the consumer 108, then the step 1220 is repeated. Once the consumer 108 changes the channel on the STB 104 or turns the power to the STB 104 off, then the method 805 proceeds to step 1225.

In step 1225, the method 805 determines if the power to the STB 104 is on. If the power is not on, then the method 805 proceeds to step 1230, where the time of receipt of the signal 126 to turn off the STB 104 is stored in the STB 104. The method 805 would then proceed to one of steps 810, 930, 1015, or 1115, depending on the consumer's 108 sharing preference.

If the power is on in step 1225, then the method 805 proceeds to step 1235. In step 1235, the time of receipt of the new channel setting is stored on the STB 104, as is the new channel setting. The method 805 would then return to step 1220.

The time/channel data 128 stored in the STB 104 as provided in the method 805 can comprise the initial desired channel setting and time of receipt of the initial desired channel setting stored in step 1215, as well as the time of receipt of the power off signal or new channel setting stored in steps 1230 or 1235, respectively. Time/channel data 128 stored in the STB 104 as provided in the method 805 alternatively can comprise the new channel setting and time or receipt of the new channel setting as received in one iteration of step 1235, as well as the time of receipt of the power off signal or new channel setting stored in step 1230 or in the next iteration of step 1235, respectively. Therefore, each instance of time/channel data 128 can comprise a start time, an end time, and a channel, wherein the STB 104 was set to the channel from the start time to the end time.

FIG. 13 is a flow chart depicting a method 820 for converting time/channel data 128 to programming data, as referenced by step 820 of FIGS. 8, 9, 10, and 11. The method 820 will be described with reference to FIGS. 1 and 13.

In step 1305, the MSO 114 to which the consumer 108 subscribes is determined. In exemplary embodiments, the specific cable or satellite provider within the MSO 114 that provides service to the consumer 108 can be determined.

In step 1310, the method 820 determines whether the data storage center 118 comprises a programming guide 132 for the consumer's 108 MSO 114. If the data storage center 118 does not comprise a programming guide 132 for the consumer's 108 MSO 114, then the method 820 proceeds to step 1315, where a programming guide 132 for the consumer's 108 MSO 114 is obtained.

In certain embodiments, the programming guide 132 can be obtained from the consumer's 108 MSO 114, wherein the MSO 114 transmits the programming guide 132 to an information processing unit 116 via a network 130. In certain embodiments, the network 130 can be the same as the networks 112, 136 utilized to transmit time/channel data 128 from the STB 104 to the information processing unit 116 and ratings 138 from the information processing unit 116 to advertisers 134. In particular embodiments, one or more of the networks 112, 130, 136 can be the Internet.

In alternative embodiments, the programming guide 132 can be input manually into the information processing unit 116.

In particular embodiments of the invention, the consumer's 108 MSO 114 can comprise multiple cable or satellite operators. In more particular embodiments of the invention, different cable or satellite operators within the MSO 114 can have different programming guides 132. In any embodiment of the invention in which a consumer's 108 MSO 114 comprises different cable or satellite operators with different programming guides 132, the programming guide 132 that indicates the content 120 available to the consumer's 108 STB 104 can be considered the programming guide 132 for the consumer's 108 MSO 114.

In step 1320, the programming guide 132 obtained in step 1315 is stored in the data storage center 118. The method 820 then proceeds to step 1325. The method 820 also proceeds directly to step 1325 from step 1310 if the data storage center 118 already comprises the programming guide 132 for the consumer's 108 MSO 114.

In step 1325, the programming guide 132 for the consumer's 108 MSO 114 is retrieved from the data storage center 118.

In step 1330, the programs shown on the consumer's 108 television 110 through the STB 104 are determined based upon the time/channel data 128 and the programming guide 132. Various methods can be utilized for determining these programs shown based upon the time/channel data 128 and programming guide 132, any of which can be implemented by those skilled in the art. For example, the programs shown can be determined by searching the programming guide 132 to determine the programs shown on the channel specified in the time/channel data 128 during the time period specified in the time/channel data 128.

In step 1335, programming data is provided based upon these programs shown. Programming data, as defined previously, comprises the programs watched, or fractions thereof, by the consumer 108 via the STB 104.

The method 820 then proceeds to one of steps 825, 935, 1020, or 1130, depending on the consumer's 108 sharing preference.

FIG. 14 is a flow chart depicting a method 510 for calculating a first set of ratings information based upon data retrieved from consumers 108 sharing time/channel data 128 continuously, as referenced by step 510 of FIG. 5. The method 510 will be described with reference to FIGS. 1 and 14.

In step 1405, programming data and associated demographic data of consumers 108 with a sharing preference of category 3, 4, or 5 are retrieved from the data storage center 118. In certain embodiments, the programming data and associated demographic data can be retrieved from the data storage center 118 with an information processing unit 116. The method 510 then proceeds to step 1410.

In step 1410, a first set of ratings information is calculated based upon programming data and associated demographic data of consumers 108 with a sharing preference of category 3, 4, or 5. In particular embodiments, the first set of ratings information can comprise the number of consumers 108 that watched a given program or fraction thereof. In more particular embodiments, the first set of ratings information also can comprise available demographic data associated with the consumers 108 that watched a given program. In still more particular embodiments, the demographic data can include demographic data provided by a consumer 108 regarding members of the consumer's 108 household 102, as well as demographic data of all individuals from the consumer's 108 zip code. The method 510 then proceeds to step 515 (FIG. 5).

FIG. 15 is a flow chart depicting a method 525 for calculating a second set of ratings information based upon data retrieved both from consumers 108 sharing time/channel data 128 continuously and consumers 108 sharing time/channel data 128 periodically, as referenced by step 525 of FIG. 5. The method 525 will be described with reference to FIGS. 1 and 15.

In step 1505, programming data and associated demographic data of consumers 108 with a sharing preference of category 2 are retrieved from the data storage center 118. In certain embodiments, the programming data and associated demographic data can be retrieved from the data storage center 118 with an information processing unit 116. The method 525 then proceeds to step 1420.

In step 1510, a second set of ratings information is calculated based upon programming data and indicator data, if present, of consumers 108 with a sharing preference of category 2 only or with a sharing preference of category 2 combined with those with a sharing preference of category 3, 4, and/or 5. In certain embodiments, the second set of ratings information can be calculated based upon only the programming data and indicator data, if present, of consumers 108 with a sharing preference of category 2. In particular embodiments, the second set of ratings information can comprise the number of consumers 108 that watched a given program, or fraction thereof. The method 525 then proceeds to step 530 (FIG. 5).

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit of the invention. Accordingly, such alternative embodiments are implicitly included in the invention described herein.

The invention can be used with computer hardware and software that performs some of the methods and processing functions described above. As will be appreciated by those in the art having the benefit of this disclosure, some of the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments have been described above in detail, the description is merely for purposes of illustration. Various modifications of, and equivalent steps corresponding to, the disclosed aspects of the exemplary embodiments, in addition to those described above, can be made without departing from the spirit and scope of the invention defined in the following claims, the scope of which is to be accorded the broadest interpretation so as to encompass such modifications and equivalent structures.

What is claimed is:

1. A method for generating television ratings for a population that comprises at least one household in a viewing group and at least one household in a demographic group, comprising the steps of:
collecting viewership data from a set-top box in each respective household in the viewing group, the set-top box in each respective household in the viewing group being owned by the respective household in the viewing group;
collecting viewership data and demographic data from a set-top box in each respective household in the demographic group, the set-top box in each respective household in the demographic group being owned by the respective household in the demographic group; and
generating television ratings based on the collected viewership data and the collected demographic data.

2. The method of claim 1, further comprising the step of identifying each household in the population as being in one of the viewing group, the demographic group, or neither group.

3. The method of claim 1, wherein the demographic group comprises a zip code group, a household demographic group, and an individualized demographic group.

4. The method of claim 3, further comprising the steps of, for each household in the zip code group:
determining the household's zip code;
determining demographic data for the zip code; and
associating the demographic data for the zip code with the household.

5. The method of claim 3, further comprising the step of, for each household in the household demographic group, receiving demographic data for the household.

6. The method of claim 3, further comprising the step of, for each household in the individualized demographic group, receiving demographic data for at least one member of the household.

7. The method of claim 1, wherein data from households in the viewing group is collected periodically, and data from households in the demographic group is collected substantially continuously.

8. The method of claim 1, wherein the population further comprises a remainder group, and wherein the step of generating television ratings based on the collected viewership data and the collected demographic data comprises the steps of:
collecting viewership data from at least one household in the remainder group; and
extrapolating viewership data and demographic data collected from each household in the demographic group to the households in the viewing group and the remainder group.

9. The method of claim 8, wherein the step of extrapolating viewership data and demographic data collected from each household in the demographic group to the households in the viewing group and the remainder group is performed using simple extrapolation techniques.

10. The method of claim 8, wherein the step of extrapolating viewership data and demographic data collected from each household in the demographic group to the households in the viewing group and the remainder group is performed using inverse demographic matrix hybrid techniques.

11. The method of claim 8, wherein the step of extrapolating viewership data and demographic data collected from each household in the demographic group to the households in the viewing group and the remainder group is performed using individual behavior system hybrid techniques.

12. The method of claim 1, wherein the viewership data collected from each respective household in the viewing group is owned by the respective household in the viewing group, and
wherein the viewership data and demographic data collected from each respective household in the demographic group are owned by the respective household in the demographic group.

13. A method for generating television ratings for a first population that comprises at least one household, comprising the steps of:
determining a viewership data sharing preference for each respective household in the first population, wherein the viewership data sharing preference indicates whether the respective household allows viewership data from the respective household to be shared;
determining a demographic data sharing preference for each respective household in the first population, wherein the demographic data sharing preference indicates whether the respective household allows demographic data from the respective household to be shared;
collecting data from a set-top box in each respective household that allows viewership or demographic data to be shared, the set-top box in each respective household that allows viewership or demographic data to be shared being owned by the respective household that allows viewership or demographic data to be shared; and
generating television ratings based on collected data, wherein the viewership data sharing preference and the demographic data sharing preference are used to determine what data to collect from each household.

14. The method of claim 12, wherein the households that allow demographic data to be shared comprise a zip code group, a household demographic group, and an individualized demographic group.

15. The method of claim 14, further comprising the steps of, for each household in the zip code group:
determining the household's zip code;
determining demographic data for the zip code; and
associating the demographic data for the zip code with the household.

16. The method of claim 14, further comprising the step of, for each household in the household demographic group, receiving demographic data for the household.

17. The method of claim 14, further comprising the step of, for each household in the individualized demographic group, receiving demographic data for at least one member of the household.

18. The method of claim 12, wherein the data collected from each respective household that allows viewership data or demographic data to be shared is owned by the respective household.

19. The method of claim 12, wherein the step of generating television ratings based on the collected data comprises the steps of:
collecting viewership data from at least one household in a second population; and
extrapolating viewership data and demographic data collected from each household that allows demographic data to be shared to households in the first population and the second population.

20. A method for generating television ratings for a population that comprises at least one household having a set-top box owned by the household, comprising the steps of:
receiving permission from a member of each respective household in the population to collect data from the set-top box owned by the respective household;
collecting data from each set-top box; and
providing television ratings based on the collected data.
